(19) United States
(12) Patent Application Publication
(10) Pub. No.: US 2007/0137408 A1
(43) Pub. Date: Jun. 21, 2007

(54) Rotary-to-linear actuator, with particular use in motorcycle control

(76) Inventor: Charles L. Lassiter, Palo Alto, CA (US)

Correspondence Address: David R. Graham, 1337 Chewpon Avenue, Milpitas, CA, 95035, US

(21) Appl. No.: 11/522,113

(22) Filed: Sep. 14, 2006

Related U.S. Application Data
(60) Provisional application No. 60/717,139, filed on Sep. 14, 2005.

(51) Int. Cl. B62K 21/12

(52) U.S. Cl. 74/551.8; 74/551.1

(57) ABSTRACT

A handle-mounted rotary-to-linear actuator is adapted for operation by hand via a rotating handgrip assembly. A motorcycle control mechanism can be manually actuated via a rotating handgrip assembly. A short-stroke rotary-to-linear actuator is adapted for operation by hand via a rotating handgrip assembly. A low-displacement rotary-to-linear actuator is adapted for operation by hand via a rotating handgrip assembly.

### BACKGROUND OF THE INVENTION

1. Field of the Invention

The invention relates to a handle-mounted rotary-to-linear actuator adapted for operation by hand via a rotating handgrip assembly. The invention also relates to a device for manual actuation of a motorcycle control mechanism via a rotating handgrip assembly. The invention also relates to a short-stroke rotary-to-linear actuator adapted for operation by hand via a rotating handgrip assembly. The invention also relates to a low-displacement rotary-to-linear actuator adapted for operation by hand via a rotating handgrip assembly.

2. Related Art

The development of the modern motorcycle began over a hundred years ago. Apparatus for effecting control of operation of the motorcycle has evolved over time. During the 1950's and 1960's, the conventions for motorcycle controls began to settle into the standards which exist today.

Apparatus for effecting control of an aspect of the operation of a motorcycle has been implemented so that the control is hand-actuated. Apparatus for effecting control of an aspect of the operation of a motorcycle has also been implemented so that the control is foot-actuated. In current conventional implementations of a motorcycle, hand-actuated throttle, front brake, and clutch controls are paired with foot-actuated gear selector and rear brake controls.

Hand-actuated motorcycle control apparatus has been implemented so that a lever assembly is used to effect control of an aspect of the operation of a motorcycle (sometimes referred to herein as “handlebar-lever-actuated control”). Hand-actuated motorcycle control apparatus has also been implemented so that a rotatable handgrip assembly is used to effect control of an aspect of the operation of a motorcycle (sometimes referred to herein as “rotatable-handgrip-actuated control”). FIG. 1 illustrates both handlebar-lever-actuated control apparatus and rotatable-handgrip-actuated control apparatus implemented on a handlebar 101: a rotatable handgrip 102 mounted on the handlebar 101 can be used together with the other parts of the rotatable-handgrip-actuated control apparatus not visible in FIG. 1 to effect the rotatable-handgrip-actuated control and a lever 103 can be used to move a cable (not visible, inside the cable sheath 104) to effect the handlebar-lever-actuated control. Typically, in a motorcycle, handlebar-lever-actuated control has been used when the control apparatus must produce a relatively large force to effect the desired control (such as is typically required to actuate a clutch or a brake), while rotatable-handgrip-actuated control has been used when the control apparatus need only produce a relatively small force to effect the desired control (such as is typically required to actuate a throttle). For instance, in current conventional implementations of a motorcycle, control of the front brake is effected using a lever assembly attached to the right handlebar of the motorcycle (i.e., the handlebar intended to be gripped by the rider's right hand when the rider is positioned on the motorcycle), control of the throttle is effected using a rotating handgrip of the right handlebar, and control of the clutch is effected using a lever assembly attached to the left handlebar of the motorcycle (i.e., the handlebar intended to be gripped by the rider's left hand when the rider is positioned on the motorcycle). One exception to the foregoing conventional implementation of hand-actuated motorcycle control is a custom motorcycle designed by Exile Cycles of North Hollywood, Calif., which includes no handlebar-lever-actuated control and in which clutch actuation is effected using rotatable-handgrip-actuated control apparatus that is part of a custom set of handlebars.

The foregoing conventions have made interfacing with many different types of motorcycle predictable. However, aspects of the conventional motorcycle control described above can be problematic. For example, an off-road motorcycle rider's feet frequently leave the footpegs during turns and low-speed maneuvers to act as stabilizers or outriggers for preventing spills. Rear brake control is conventionally implemented so that such control is actuated by a rider using the rider's right leg and foot. However, if the rider's right leg and foot extend so that the foot leaves the footpeg to provide stabilization as discussed above, the rider no longer has access to the rear brake control. Conversely, if, in such situations, the rider leaves the rider's right foot planted on the right footpeg, the rider is at risk of not being able to extend the leg and foot in time to prevent a slide or spill.

Provision of symmetric access to the rear brake control (i.e., providing rear brake control that can be activated using either the right leg and foot or the left leg and foot) would desirably enable a rider to use the right or left leg for stabilization as described above without sacrificing the ability to actuate the rear brake at the same time. Such innovation would increase both performance and safety. However, the implementation of rear brake control so that such control can be activated by a rider using the rider's left leg and foot may introduce undesirable complexity and/or expense, particularly since gear selection control is also conventionally effected using the left leg and foot.

### SUMMARY OF THE INVENTION

As appreciated from the detailed description of the invention below, a solution to the above-described asymmetric, rear brake actuation problem can be found in the hands, rather than at the feet. Cognitively, the conventional handlebar-mounted controls paradigm puts acceleration/deceleration and stopping (throttle and front brake) in the right hand while the left hand manages power delivery through the clutch. The throttle utilizes a handlebar-mounted rotating handgrip assembly (T-RHA) while the front brake and clutch are controlled with handlevers). The invention modifies this conventional paradigm to provide improved motorcycle control.

In accordance with the invention, a mechanism is provided which converts the rotation of a handgrip operated by an articulated hand/wrist/forearm, with an average maximum rotating range of about 90 degrees, to a linear motion useful for displacing linear mechanisms such as cables, rods, arms, hydraulic pistons, plungers, and other linear devices. The mechanism can be limited to a fixed range which matches one forward and backward movement of the hand/wrist/forearm; this range can be, for example, similar to the range of a doorknob and latch. Alternatively, the mechanism can incorporate ratcheting assemblies which provide a continuous directional action by locking the gears as the hand resets or releases and rotates backward to continue a forward drive (and vice versa); this can be, for example, similar to the ratchet of a manual winch or socket wrench/ratchet drive mechanism. While suitable for a host of applications such as latches, switches and valves, the invention can be particularly advantageous when used for motorcycle control applications.

According to one embodiment of the invention, apparatus for effecting control of the operation of a vehicle that includes a handlebar, a brake assembly and a clutch assembly, includes: i) a rotatable handgrip assembly mounted on the handlebar, the rotatable handgrip assembly operably connected to the clutch assembly to enable actuation of the clutch assembly; and ii) a lever assembly attached to the handlebar, the lever assembly operably connected to the brake assembly to enable actuation of the brake assembly. It is anticipated that the foregoing control apparatus can be particularly useful when implemented in a two-wheeled vehicle, such as motorcycle, since such vehicles are often controlled by a rider using handlebars. The rotatable handgrip assembly can be mounted on, and the lever assembly attached to, the same handlebar, e.g., a right or left handlebar adapted to be held by an operator's right or left hand, respectively, when the operator is positioned on the vehicle. The control apparatus can be—implemented so that actuation of the brake assembly by the lever assembly effects control of a rear brake of the vehicle. As discussed in detail elsewhere herein, this can be especially advantageous when the vehicle is a motorcycle. Moreover, in that case, the rotatable handgrip assembly can be mounted on, and the lever assembly attached to, a left handlebar of the motorcycle, advantageously achieving a cognitive symmetry in the control interface, as also discussed in more detail herein.

The invention encompasses a variety of aspects. In one aspect, the invention concerns a Rotating Handgrip Assembly (RHA) actuating mechanism which is superior to a lever-actuated mechanism due to the elimination of the need to release fingers from the handgrip for actuation, thus providing greater control and stability to the user.

In another aspect, the invention concerns a Rotating Handgrip Assembly (RHA) for a clutch-actuating mechanism which provides a control interface superior to lever-actuated systems. The forward rotation actuation matches the existing throttle control paradigm: rearward rotation=acceleration and forward rotation=deceleration.

In another aspect, the invention concerns a Rotating Handgrip Assembly (RHA) actuating mechanism which is superior to lever extensions in a crash or accident: the RHA is far less susceptible to breakage, bending, or dislocation in a spill due to its cylindrical bar-mounted profile.

In another aspect, the invention concerns a Rotating Handgrip Assembly (RHA) actuating mechanism with a housing which exhibits a high degree of rotational positionability relative to other controls due to the circular symmetry of the handgrip's cylindrical bar-mounted profile.

In another aspect, the invention concerns a Rotating Handgrip Assembly (RHA) actuating mechanism which is applicable to multiple individual control systems such as clutch or brake controls.

In another aspect, the invention concerns a Rotating Handgrip Assembly compound actuator (X-RHA) mechanism which is applicable to multiple combined control systems such as clutch+brake, throttle+brake, lever-actuated brake+RHA clutch, etc.

In another aspect, the invention concerns a Rotating Handgrip Assembly (RHA) actuating mechanism which is easily transferrable between handles or handlebar mounts (e.g., 0.875″/22 mm) of other machines since it interfaces with standard (stock) control systems.

In another aspect, the invention concerns multiple components for lengthening the jacket of the stock cable, thus removing slack from the sliding steel leader: the long-nosed adjuster insert, the split mid-cable insert, and the split tail addition are such components.

In another aspect, the invention concerns a Rotating Handgrip Assembly (RHA) with a control housing featuring a haptic feedback device composed of a spring-loaded detent contacting a pattern of indentations with varying frequency such that the rider can sense where the control is in its range of movement.

In another aspect, the invention concerns a Rotating Handgrip Assembly (RHA) with a control housing featuring a collet lock mounting component which automatically centers the mechanism housing on the handle or handlebar axis while providing a quick-release mounting action.

In another aspect, the invention concerns a Rotating Handgrip Assembly (RHA) actuating mechanism with a rotatable housing which uses the radial length and mass of its housing to provide increased torque and/or decreased muscle force required to actuate the mechanism.

In another aspect, the invention concerns a Rotating Handgrip Assembly compound actuator (X-RHA) with a rotatable housing which integrates a conventional lever-actuated cable or conventional lever-actuated hydraulic mechanism to provide increased torque and/or decreased muscle force required to actuate the mechanism.

In another aspect, the invention concerns a Rotating Handgrip Assembly compound actuator (X-RHA) for clutches with a rotatable housing which integrates a conventional lever-actuated cable brake or conventional lever-actuated hydraulic brake mechanism in order to provide the most leverage consistency in the vertical axis due to the shorter horizontal range of motion of the brake lever.

In another aspect, the invention concerns a Rotating Handgrip Assembly compound actuator (X-RHA) with a rotatable housing in which the combination of lever-actuated control B into the housing of X-RHA control A enhances the function and usability of both X-RHA control A and lever-actuated control B, while increasing available space on the handle or handlebar.

In another aspect, the invention concerns a Rotating Handgrip Assembly compound actuator (X-RHA) with a rotatable housing in which the combination of lever-actuated control B into the housing of X-RHA control A maintains the position of the wrist and thumb relative to the lever in order to maximize the strength of the forearm muscles through the wrist, thus maximizing finger strength on the lever.

In another aspect, the invention concerns a Rotating Handgrip Assembly (RHA) with a rotatable housing featuring a hub lock mounting component with set screws and knurled locking plates which also can be used to center the mechanism housing on the handle or handlebar axis.

In another aspect, the invention concerns a Rotating Handgrip Assembly (RHA) with a rotatable housing featuring a hub lock mounting component which provides a flat profile to the medial exterior wall of the housing where it meets the handlebar.

In another aspect, the invention concerns a Rotating Handgrip Assembly (RHA) with a rotatable housing featuring a pivot clamp mounting component which attaches to the medial exterior wall of the housing and allows standard lever-type handlebar control perches to bolt to its clamp section in order to provide additional leverage to the rider for rotating the housing.

In another aspect, the invention concerns a Rotating Handgrip Assembly compound actuator (X-RHA) with a rotatable housing which uses the mass of its housing and radial length of conventional cable or hydraulic lever and perch assemblies mounted to matching pivot clamps to provide increased torque and/or decreased muscle force required to actuate the rotating mechanism.

In another aspect, the invention concerns a Rotating Handgrip Assembly compound actuator (X-RHA) with a rotatable housing for which the addition of conventional lever-actuated control B onto the housing of X-RHA control A via the pivot clamp enhances the function and usability of both X-RHA control A and conventional lever-actuated control B.

In another aspect, the invention concerns a Rotating Handgrip Assembly compound actuator (X-RHA) with a rotatable housing for which the addition of conventional lever-actuated control B onto the housing of X-RHA control A via the pivot clamp maintains the position of the wrist and thumb relative to the lever in order to maximize the strength of the forearm muscles through the wrist, thus maximizing finger strength on the lever.

In another aspect, the invention concerns a Rotating Handgrip Assembly compound actuator (X-RHA) for clutches with a rotatable housing which accommodates a conventional lever-actuated cable or conventional lever-actuated hydraulic perch assembly for brake actuation mounted to a matching pivot clamp in order to provide the most leverage consistency in the vertical axis due to the shorter horizontal range of motion of the brake lever.

In another aspect, the invention concerns a Rotating Handgrip Assembly (RHA) actuating mechanism with an integrated locking component which allows the user to lock the mechanism in a particular state with one finger, then release the lock by rotating the mechanism.

In another aspect, the invention concerns multiple implementations for increasing a hand's torque on a rotating handgrip assembly (RHA) without significantly decreasing the hand's hold or “grip” on the machine.

In another aspect, the invention concerns implementation of an interlocking tube/rack wheel which provides high rotational positionability with high strength.

In another aspect, the invention incorporates a housing and components capable of accommodating different pinion/rack wheel gear ratio pairs with common center distances which the user can change to suit his preferences.

In another aspect, the invention concerns a Rotating Handgrip Assembly (RHA) with a forward-rotating actuating mechanism that includes a stop block component which provides the secure, fixed, non-rotating feel of a permanent, non-articulated handgrip when the user is not actuating the mechanism when the user is seated behind the bars and is not actuating the mechanism.

In another aspect, the invention concerns a Rotating Handgrip Assembly (RHA) with a forward-rotating actuating mechanism that includes a stop block component which provides the secure, fixed, non-rotating feel of a permanent, non-articulated handgrip when the user is seated behind the bars applying rearward pressure and not actuating the mechanism.

In another aspect, the invention concerns a screw-actuated hydraulic piston component suitable for hydraulic brake controls, hydraulic clutch controls, and other hydraulic systems.

In another aspect, the invention concerns a hydraulic piston component which does not require a return spring for assembly or proper actuation of a sprung (e.g. clutch) mechanism.

In another aspect, the invention concerns a hydraulic barrel (cylinder) component which can be manufactured significantly shorter than its lever-actuated counterpart due to the elimination of a return spring for assembly or proper actuation of a sprung (e.g. clutch) mechanism.

In another aspect, the invention concerns a supplemental system (secondary arm) for foot pedal-actuated mechanisms which leaves normal foot pedal function intact while providing auxiliary hand-actuated operation.

In another aspect, the invention concerns a switch valve assembly which affords the alternating use of two hydraulic master cylinders with one slave cylinder without misdirecting hydraulic fluids into the reservoir of the inactive master cylinder.

In another aspect, the invention concerns a switch valve assembly suitable for use with multiple types and brands of hydraulic master cylinders without modifications to the switch valve assembly or the master cylinders.

In another aspect, the invention concerns a magnetic switch valve assembly which is enhanced for extreme conditions by the use of magnets for securing the switch mechanism.

### BRIEF DESCRIPTION OF THE DRAWINGS

FIG. 1 is a side view of a handlebar on which both handlebar-lever-actuated control apparatus and rotatable-handgrip-actuated control apparatus are implemented.

FIG. 2A is a side view of a hand imparting forward rotation to a handgrip using muscular flexion of the hand and wrist.

FIG. 2B is a side view of a hand imparting rearward rotation to a handgrip using muscular extension of the hand and wrist.

FIG. 3A is a perspective view of a throttle control tube on which is formed a cable flange.

FIG. 3B is a perspective view of a handgrip positioned on a throttle control tube including a stop flange.

FIGS. 4A through 4L are each a cross-sectional view of a grip mounted on a tube, illustrating a variety of grips that can be used with embodiments of the invention.

FIGS. 5A through 5N are each a perspective view of a grip that can be used with embodiments of the invention.

FIG. 6A is a side view of a locking flange formed with a perimeter having a pattern of regularly spaced points.

FIG. 6B is a side view of a locking flange formed with a perimeter having a pattern of regularly spaced petal shapes.

FIG. 6C is a side view of a locking flange formed with a perimeter having a pattern of regularly spaced gear-like teeth.

FIG. 6D is a side view of a locking flange having a hexagonally shaped perimeter.

FIG. 7A is a perspective view of a tube lever.

FIG. 7B is a perspective view of one embodiment of a thumb paddle.

FIG. 7C is a perspective view of another embodiment of a thumb paddle.

FIG. 8A is a perspective view of a rack wheel and an associated bearing that can be used in embodiments of an RHA according to the invention that include a stationary housing.

FIG. 8B is an exploded perspective view of a collet lock, two sealed bearings, and a rack hub that can be used in embodiments of an RHA according to the invention that include a rotatable housing.

FIG. 8C is a cross-sectional view of the collect lock, two sealed bearings, and rack hub of FIG. 8B attached to a handlebar within a housing.

FIG. 8D is a perspective view of a hub lock and a rack hub that can be used in embodiments of an RHA according to the invention that include a rotatable housing.

FIG. 9A is a perspective view of a stop block.

FIG. 9B is a perspective view of a stop block positioned in a housing of an RHA according to the invention.

FIG. 10 is a perspective view of a pinion and associated bearing that can be used in embodiments of the invention.

FIG. 11A illustrates two different gear ratios with a constant center distance between gear axes.

FIG. 11B is a side view of rack and pinion gear sets, including a threaded pinion hub and threaded pinion bore.

FIG. 12 is a perspective view of a screw with multiple starts and straight splines that can be used in embodiments of the invention.

FIG. 13 is a side view of a coupler that can be used with an RHA for cable actuation according to the invention.

FIG. 14 is a side view of a piston that can be used with an RHA for hydraulic actuation according to the invention.

FIG. 15A is a perspective view of a handlebar on which is mounted a stationary housing RHA for cable actuation, according to an embodiment of the invention.

FIG. 15B is a perspective view of a handlebar on which is mounted a rotatable housing RHA for cable actuation, according to an embodiment of the invention.

FIG. 15C is a perspective view of a handlebar on which is mounted a stationary housing RHA for hydraulic actuation, according to an embodiment of the invention.

FIG. 15D is a perspective view of a handlebar on which is mounted a rotatable housing RHA for hydraulic actuation, according to an embodiment of the invention.

FIG. 16 is a side view of a two-piece side plate and associated one-piece gasket.

FIG. 17 is a side view of a handgrip and housing of an RHA according to the invention, including a mirror mount, kill switch and push-button lock.

FIG. 18 is a perspective view of a mudguard and integrated fasteners.

FIG. 19 is a cross-sectional view of part of a RHA for cable actuation, according to an embodiment of the invention, illustrating construction and assembly of parts of a RHA for cable actuation that are enclosed within a housing.

FIGS. 20A through 20D are photographs showing perspective views and a side view of part of a stationary housing RHA for cable actuation, according to an embodiment of the invention, illustrating construction and assembly of the RHA.

FIGS. 21A and 21B are cross-sectional views of part of a rotatable housing RHA for cable actuation according to the invention, illustrating rotation of a housing around a locked rack hub during operation of the RHA.

FIG. 22 is a perspective view of a spring-loaded detent and a rack wheel having a scored gradation pattern on an inside surface of the rack wheel to enable the provision of haptic feedback when rotating the handgrip.

FIG. 23 is a perspective view of a cable tension adjuster with slotted centering insert and associated o-ring that can be used in embodiments of the invention.

FIG. 24 is a cross-sectional view of part of an RHA for hydraulic actuation, according to an embodiment of the invention, illustrating construction and assembly of parts of a RHA for hydraulic actuation that are enclosed within a housing.

FIG. 25 is a perspective view of an internal snap ring and an external snap ring and corresponding grooves that can be used with embodiments of the invention.

FIGS. 26A and 26B are cross-sectional views of part of a rotatable housing RHA for hydraulic actuation according to the invention, illustrating rotation of a housing around a locked rack hub during operation of the RHA.

FIG. 27 is a cross-sectional view of part of a B-RHA for hydraulic actuation, according to an embodiment of the invention, illustrating construction and assembly of parts of a RHA for hydraulic actuation that are enclosed within a housing.

FIGS. 28A and 28B are opposing side views of a secondary arm for cable and rod-actuated rear drum brakes.

FIGS. 29A and 29B are cross-sectional views of a switch valve assembly and a magnetic switch valve assembly, respectively, that can be used with embodiments of the invention.

FIGS. 30A through 30F are cross-sectional views of a switch valve assembly illustrating an actuation sequence of the switch valve assembly.

FIG. 31 is a longitudinal cross-sectional view of part of an X-RHA, according to an embodiment of the invention, adapted for mounting on a left handlebar to enable clutch and rear brake actuation.

FIG. 32 is a longitudinal cross-sectional view of part of an X-RHA, according to an embodiment of the invention, adapted for mounting on a right handlebar to enable throttle and front brake actuation.

FIG. 33 is a perspective view of an X-RHA, according to an embodiment of the invention, adapted to enable lever action of a brake master cylinder and clutch actuation, and including a rotatable housing.

FIG. 34A, 34B and 34C are longitudinal cross-sectional views of a first ratcheting mechanism, a second ratcheting mechanism and a push-button lock mechanism, respectively, that can be used with embodiments of the invention.

FIGS. 35A, 35B and 35C are perspective views of three types of cable spacers that can be used with an RHA according to the invention.

FIG. 36 is a perspective view of a thick inset side plate and locking flange tube for use with an RHA.

FIG. 37 is a perspective view of piston face holes and primary seal on return spring.

FIG. 38 is a perspective view hydraulic lever assembly pivot clamp parts and rotating housing.

FIG. 39 is a perspective view of horizontal and vertical pivot clamps.

FIG. 40 is a table showing several possible combinations of X-RHA Clutch and Rear Brake Hybrids.

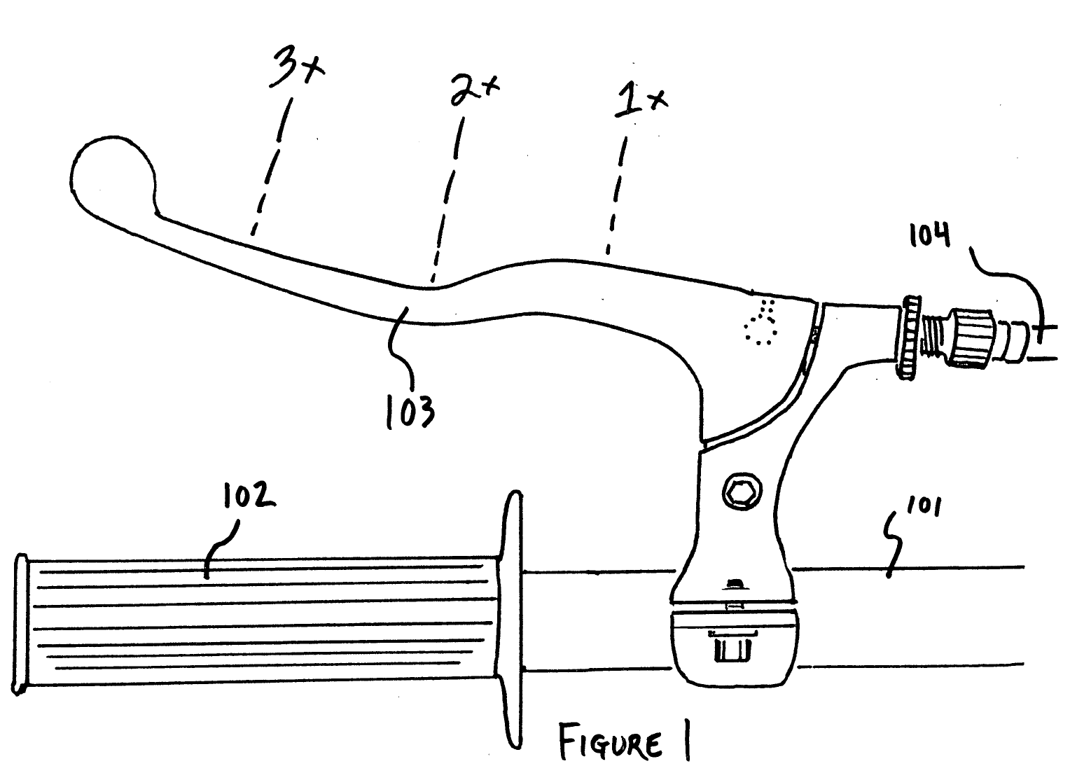

### DETAILED DESCRIPTION OF THE INVENTION

### I. Overview

The invention takes advantage of an opportunity in asymmetry: by converting the clutch control from lever-actuation (as is the case with conventional motorcycle control apparatus) to a handlebar-mounted Rotating Handgrip Assembly (C-RHA), we avail the left hand lever to rear brake actuation. This conversion unifies the usage of left and right hand levers for brake control, a change which also unifies the cognitive association of levers with stopping. In addition, this conversion unifies the usage of left and right hand handlebar-mounted rotating handgrip assemblies for acceleration, a change which also unifies the cognitive association of handlebar-mounted rotating handgrip assemblies with accelerating.

Herein, the invention is often particularly described as implemented in a motorcycle, but the invention can apply broadly to other vehicles having handlebars, such as other types of two-wheeled vehicles, all-terrain vehicles (ATVs), etc. Additionally, the terms “rider” and “operator” are each sometimes used to describe a person operating a vehicle of which the invention is part: those terms are used interchangeably.

This alteration provides another significant benefit. Levers are extremely susceptible to bending and braking, even in a mild spill. When the right front brake lever is broken, the rider still has the use of the rear brake to slow the machine. When the left clutch lever is broken, the rider is stuck with no safe way to shift the machine's gears. By changing to a clutch-actuating handlebar-mounted Rotating Handgrip Assembly (C-RHA), the likelihood of losing actuation of the clutch mechanism is reduced drastically.

Herein, a handlebar-mounted rotating handgrip assembly which controls fuel delivery is not referred to as a “throttle.” Instead, the abbreviation T-RHA is used for throttle control via a rotating handgrip assembly. Similarly, the abbreviation C-RHA is used for clutch control via rotating handgrip assembly.

A C-RHA (clutch control) for a motorcycle can be mounted on the left handlebar, which, in a conventional motorcycle, is where a fixed grip is normally found. A C-RHA can have an external appearance (including the operation of the apparatus that is visible to a rider or other operator) that is similar to that of a conventional straight-pull motorcycle T-RHA (throttle control); however, the internal construction of the two is different, as evident from the description below of a C-RHA according to the invention. Further, unlike a conventional T-RHA for a motorcycle, a C-RHA can be constructed so that resistive spring force of the C-RHA is encountered when the handlebar grip is rotated forward, that is, over and toward the front of the motorcycle. The C-RHA can be constructed so that such forward rotation disengages the clutch and slows the motorcycle. Since forward rotation of a T-RHA as conventionally implemented on a motorcycle closes the throttle, also slowing the motorcycle, construction of a C-RHA in this manner can advantageously achieve a cognitive symmetry in the control interface: backwards rotation produces acceleration and forward rotation produces deceleration. However, while construction of a C-RHA in this manner can be advantageous for the reason given above, the invention can also be implemented so that backward rotation of the C-RHA disengages the clutch and slows the motorcycle. Construction of a C-RHA so that forward rotation engages the clutch can have an additional benefit: when the rider is not actuating the C-RHA, the C-RHA handlebar exhibits the secure, fixed, non-rotating feel of a permanent, non-articulated handgrip due to the C-RHA housing's internal block. This secure impression is due to the fact that when a rider is positioned behind the controls, the rider naturally tends to pull lightly backwards and downwards on the handlebars. The T-RHA's (throttle's) rearward rotation does not provide this secure feel.

As mentioned previously, the device can be manufactured for rearward rotation with minimal internal changes. Some riders may have preferences or physical limitations which require rearward rotation.

Beyond forward-only and rearward-only actuation, it may also be desirable to use an internal hydraulic switch mechanism described later to enable both forward and rearward actuation of an hydraulic system.

While the control paradigm described above (i.e., rotational input to produce acceleration and lever actuation to produce braking) provides a desirable and consistent interface to a rider, there may be situations in which a different control paradigm is deemed appropriate. For example, a rider may want to use a rotating handgrip assembly for brake actuation. A brake-actuating rotating handgrip assembly (B-RHA) can be easily derived from a C-RHA by appropriately modifying the C-RHA: modifications that can be made to produce such structure are described in more detail below.

Multiple actuators (i.e., a B-RHA, C-RHA, and/or T-RHA) can be combined in a single rotating handgrip assembly. Such a multi-actuator rotating handgrip assembly is generally categorized herein as an X-RHA (where X represents some combination of T, B, C and other controls such as levers). Some examples of such a multi-actuator rotating handgrip assembly are described below in the section entitled “X-RHA's: The Rotating Handgrip Assembly as a Compound Actuator,” such as, for instance, a combined clutch-actuating/brake-actuating rotating handgrip assembly, a combined throttle-actuating/brake-actuating rotating handgrip assembly, and a combination of a conventional lever-operated brake master cylinder with a C-RHA in a rotatable housing. These X-RHA's can be designed to completely replace the stock lever controls, or work with them by mounting the stock lever controls to a pivot clamp component which uses the radial length of a stock lever and perch to provide additional leverage and torque for rotating actuation. Devices for increasing leverage and torque for the RHA are also described below.

### II. The Biomechanics of The Hand, Wrist, Forearm

In order to fully appreciate the advantageous characteristics of an RHA according to the invention, it is useful to review some of the capabilities and limitations of the human arm. A conventional handle-bar-mounted lever-actuated control (e.g., conventional lever-actuated clutch or brake control for a motorcycle) is operated by the flexion of one or more fingers while the thumb and remaining fingers grip the handlebar. One finger can be used to pull the lever if that finger is strong enough, or as many as four fingers may contribute to the pull. However, each finger which leaves the handlebar to pull the lever results in a weaker hold by the rider on the handlebar. As demands on (e.g., the strength of) a rider's grip increase (e.g., because the terrain roughens), a weak grip can become a liability.

The C-RHA can be rotated with a constant five-fingered grip. The rotating grip is operated by flexing and extending the wrist joint, often in concert with some forearm movement over the top of the handlebar to provide extra range of motion and extra leverage. While the C-RHA can easily be manufactured to operate with a rearward rotation (top surface of grip moving towards the rear of the vehicle) or with a forward rotation (top surface of grip moving towards the front of the vehicle) or, in some cases, both forward and rearward rotation, it is the forward rotation which helps create the cognitive symmetry of the control with the existing T-RHA (throttle) paradigm: forward rotation for deceleration and stopping; rearward rotation for acceleration and speed. With a significant portion of the population facing the challenges of dyslexia and “sided-ness” issues, favoring physical and cognitive symmetry for controls is a significant improvement.

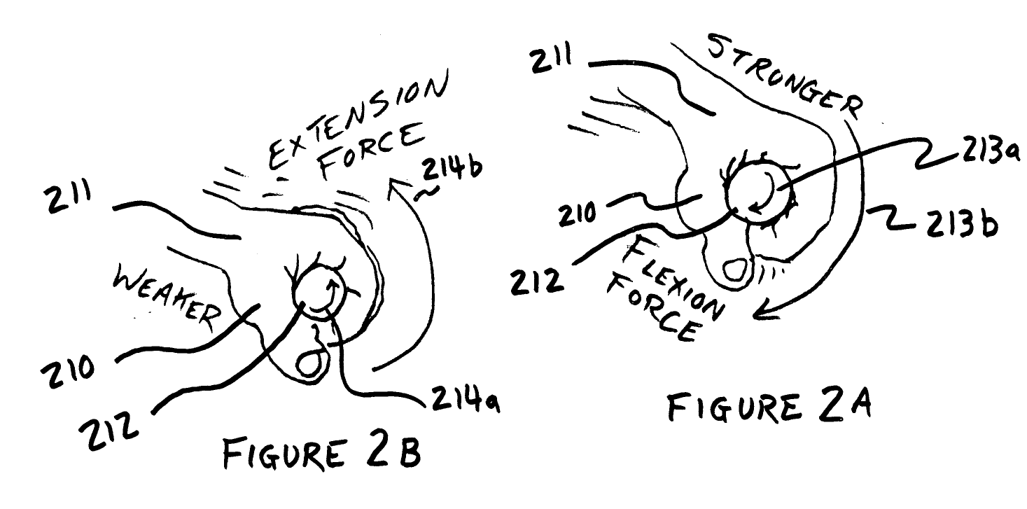

As shown in FIG. 2A, the forward rotation (indicated by the rotational arrows 213a and 213b) results from muscular flexion of a hand 210 and wrist 211 on a handgrip 212. As shown in FIG. 2B, the rearward rotation (indicated by the rotational arrow 214a and 214b) results from muscular extension of the hand 210 and wrist 211 on the handgrip 212. Both flexion and extension of the hand and wrist may be aided with a “leveraging” forearm movement over the handlebar to provide extra range of motion and extra leverage.

For proper operation of the rotating assembly, it can be desirable that the rotating assembly be constructed in view of the average range of rotation (flexion and extension) of a rider's wrist. While an extremely agile wrist may rotate the grip as much as 100 degrees (about one quarter revolution of the grip/tube around the handlebar), a more practical average is around 75 degrees (about one fifth of a revolution of the grip/tube around the handlebar). Some riders may prefer an even shorter stroke, as little as 30 to 40 degrees, which can be achieved in various configurations. Consideration of these parameters can be important in the implementation of the C-RHA.

The hand/wrist/forearm of a rider operates the C-RHA similarly to the T-RHA (throttle control). However, the T-RHA encounters resistance in the form of spring force as the rider rotates the grip rearward, whereas the embodiment of the C-RHA described above encounters resistance in the form of spring force as the rider rotates the grip forward due to the different internal spring mechanisms of the carburetor versus clutch. This is fortunate since the resisting spring forces for clutch actuation are typically greater than those for throttle actuation. The fortune lies in the fact that as the elbow is raised, the flexion musculature of the forearm is typically becomes stronger than the extension musculature of the forearm, so the extra resistance encountered by the rider from the C-RHA is matched by a stronger set of muscles. This human feature, combined with the upright seating position of the off-road motorcycle and frequent use of the standing position by the off-road rider, makes forward actuation both practical and desirable.

As mentioned previously, the device can be manufactured for rearward rotation with minimal internal changes. Some riders may have preferences or physical limitations which require rearward rotation. Also, some riders may prefer the convention of rearward-actuated rotating handgrips over the cognitive throttle symmetry of forward actuation.

Beyond forward-only and rearward-only actuation, it may also be desirable to use an internal hydraulic switch mechanism described later to enable both forward and rearward actuation of an hydraulic system.

As the forces required to actuate clutch and brake systems increase, it may be desirable to provide the rider with devices to increase his leverage and torque. These devices can offset the extended travel which would be required to actuate the control given nothing but a standard grip & tube rotated with a constant muscle force.

Leverage devices for the rotating grip are detailed in the tube lever section below. Leverage devices for the rotatable housing and grip are detailed in the accessories section below.

The final biomechanical issue to examine is grip strength. While the conventions for grip and tube size have already been defined by the motorcycle industry, their impact on finger strength for lever actuation needs to be examined more carefully. According to research done by Li and O'Driscoll, finger strength diminishes drastically as the wrist and thumb deviate from their respective optimal grip positions. For the wrist, the optimal position to acheive maximum finger contraction force is around 25 degrees of extension. The thumb's corresponding position should be around 5 degrees of ulnar deviation. Fortunately, this corresponds very closely to the wrist and thumb positions which result from grasping the standard motorcycle grip. However, as either wrist or thumb is forced out of its optimal position, finger flexion weakens markedly.

This trait of the human hand and forearm is consistent for both men and women with almost no differences. It becomes especially important when the Rotating Handgrip Assembly is partnered with a conventional lever control on the left handgrip. Since the wrist and fingers are going to be rotating around the bar regularly, actuating a stationary lever with those fingers at maximum finger strength presents a problem. A stationary lever will only be pulled with maximum finger strength at one point in the rotating range of the RHA. As the grip is turned and one or more fingers attempt to pull the lever, the weakness surfaces. This irregularity is non-optimal and unacceptable from a safety standpoint.

However, if the lever were to rotate with the grip, an ideal wrist and thumb relationship would be maintained, and finger strength would not vary as the hand rotated around the bar with the grip and lever. Furthermore, this presents the rider with an opportunity to utilize a conventional lever for two different forms of leverage: the conventional finger pull on the lever, and the unconventional finger press down on the lever in order to apply more rotating force through a RHA with a rotatable housing.

The result is dual-axis leverage with a conventional lever, where the radial length of the lever out from the center of the bar and perch provides anywhere from a 1.5× to 2× increase in torque on the RHA with a rotatable housing. Deriving the range and amount of this increase are non-obvious. With the index and middle fingers pressing down on the top of the lever while the thumb and smaller fingers remain gripping and twisting the RHA, a straddled application of force results where the median torque represents a weighted combination of the two forces. The weighting is a function of the unequal amount of force each finger contributes to the total torque.

Our measurements were derived with the use of a torque jig. A torque wrench calibrated in inch pounds was mounted vertically with proper geometry into a wooden base. The ratcheting axis of the torque wrench was mounted to a short section of ⅞″ handlebar with a left grip and left hand lever and perch mounted at typical spacing. Measurements were taken with fingers and torque applied to the grip only, then with index and middle fingers pressing down on the top of the lever while the remaining fingers simultaneously gripped and twisted the handlebar. The results are detailed above, but the increase in torque with the addition of the lever force is undeniable as the torque setting on the wrench increases. For example, one tester achieved a maximum grip-only torque of 70 to 85 inch pounds, but jumped to 130 to 145 inch pounds maximum with the use of the lever.

The dual-axis leverage design makes short-throw RHA rotation ranges of 30 to 40 degrees feasible even for heavier clutch springs and brakes.

### III. Overview of RHA

A. General Description of Some Embodiments of the Invention

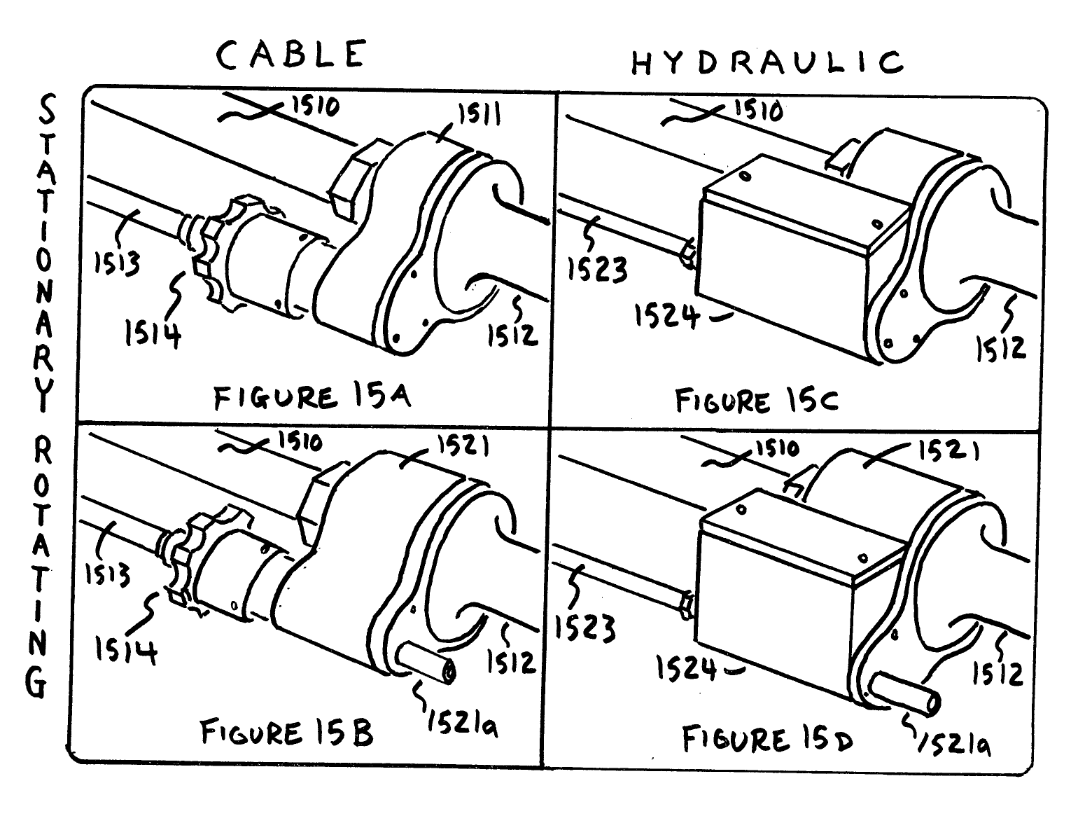

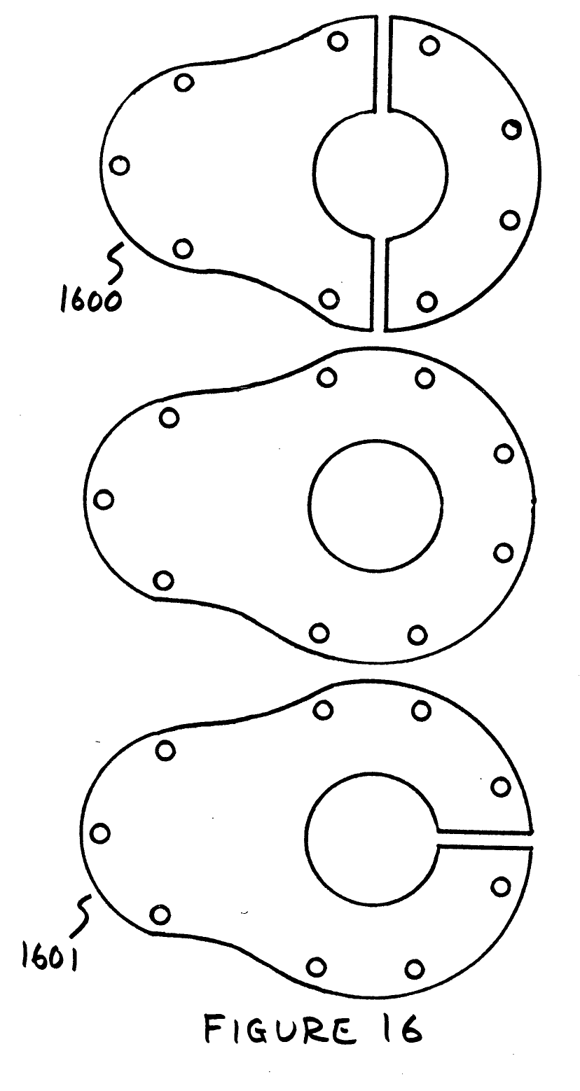

In general, an RHA in accordance with the invention converts a rotational control input from an operator (e.g., a rider, such as a rider of, for example, a motorcycle or other two-wheeled vehicle, or an all-terrain vehicle) of a vehicle of which the RHA is part to a translational output that can be used to drive a controlled assembly (such as, for example, a clutch assembly or a brake assembly, embodiments of both of which are described in more detail below) which can be actuated in any appropriate manner (such as, for example, by cable-actuation or hydraulic actuation, embodiments of both of which are described in more detail below). The rotational control input can be applied to, for example, a rotatably mounted handgrip of a handlebar of the vehicle (this can be accomplished, for example, by positioning a grip in a fixed position on a tube, which is, in turn, rotatably mounted on the handlebar. In response to the rotational control input, a rack assembly is rotated to produce corresponding rotation of a mating pinion gear, or the pinion gear is rotated about a rack assembly to produce rotation of the pinion gear. Rotation of the pinion gear results in rotation of a screw which, in turn, produces translational movement of a coupler or piston into which the screw is threaded. The translational movement of the coupler or piston produces cable actuation or hydraulic actuation of the controlled assembly. Particular embodiments of the invention in accordance with the foregoing description are discussed in more detail below (e.g., FIGS. 15A through 15D, discussed below, are perspective views of the exterior of RHAs according to embodiments of the invention that are constructed and operate in accordance with the foregoing description). However, those skilled in the art can appreciate that the invention can be implemented using apparatus other than the particular apparatus of those embodiments and, moreover, can be implemented in a manner other than the general approach described above, in accordance with the principles of the invention.

B. Hand-Actuated Control Apparatus Components

The following describes aspects of components that can be used in the implementation of hand-actuated control apparatus in accordance with the invention. In particular, most of the discussion concerns components that can be used in implementing rotatable-handgrip-actuated control apparatus, such as an RHA (rotating handgrip assembly) in accordance with the invention.

1. Conventional Throttle Tube Flanges: the Cable Flange and the Stop Flange

To provide context for the description of tube flanges that can be used with an RHA according to the invention, conventional motorcycle throttle flanges are described. There are two types of flanges commonly found on modern motorcycle throttle control tubes: the cable flange and the stop flange. The most significant of the two is the cable flange, since the cable flange acts as a guide and anchor for the throttle cable. The cable flange is a sheaved flange that is covered by the throttle control housing and usually only forms part of a circle (often an arc quadrant) instead of extending to form an entire radial rim. FIG. 3A is a perspective view of a throttle control tube 310 on which is formed a cable flange 311. In modern straight-pull throttle control housings, the throttle cable makes a 90 degree turn inside the housing to align with the center channel and anchor point of the cable flange. This turn can be formed into the housing itself, but, preferably, the cable will be curved around an internal routing pulley which rotates as the throttle is opened and closed.

The stop flange is less common. The stop flange is positioned outside of the throttle control housing and is plainly visible. The stop flange forms an entire ring or rim which is similar to the grip flange found on an end of most grips. The stop flange acts as a stop for the grip flange as the grip flange slides onto the tube during assembly. FIG. 3B is a perspective view of a grip 320 positioned on a throttle control tube including a stop flange 321 (the remainder of the tube is inside the grip 320 and therefore not visible in FIG. 3B). The stop flange prevents the sticky rubber grip flange from contacting the throttle control housing during operation (otherwise the rubber grip flange would rub on the housing and prevent the throttle control tube from turning freely). The stop flange is molded with the tube and the plastic (often nylon) of the stop flange rotates smoothly even when contacting the throttle control housing. Unfortunately, the stop flange can make the throttle control housing/tube/cable assembly process more difficult; this may be why the stop flange is becoming less common. The stop flange also makes the plastic molding process more difficult since the stop flange is a second extrusion of the tube and therefore may not form correctly, thus cutting down on production yields.

As indicated above, the stop flange may be fading out of modern motorcycle designs and could be replaced by a plastic grip washer. A grip washer is basically the same shape as a stop flange, but is assembled separately as either a one piece washer which slips on to the throttle control tube before the grip or a split-ring washer which can be positioned around the tube on after assembly of the grip on to the tube. Unlike a stop flange, a grip washer cannot prevent a grip from sliding too far onto a tube, but a grip washer can reduce friction between a grip flange and a throttle control housing that would otherwise occur if the grip washer was not present, thus keeping the throttle control tube rotating smoothly. Most grip washers are also easy to bend out of the way or remove, as necessary or desirable, during assembly, thus facilitating assembly.

Below, the description of RHAs in accordance with the invention is generally made with respect to tubes including a stop flange or around which a grip washer is positioned.

2. The RHA Handgrip: The Grip and Tube

Fundamentally, the handgrip is composed of two parts: the grip itself (usually made of thermoplastic elastomers, synthetic rubbers, or rubber-like compounds), which provides comfort and traction for the fingers, and the underlying tube (usually made of plastic, such as nylon or Delrin, but sometimes made of carbon-fiber composites or of aluminum, typically 6061 grade) which provides structure for the grip and facilitates the smooth rotation of the grip and tube around the metal handlebar over which the tube fits.

(Examples of materials that can be used for a grip and a tube, applicable to any embodiment of the invention, are described in more detail below.) The tube fits inside of the grip (and can be held in place by friction between the two) and the result is a comfortable, tractive, cylindrical handgrip component. This tube and grip component can be closed at the end opposite that which fits over the handlebar or can be open-ended to allow for other equipment to mount within the outer end of the metal handlebar (bar-ends or handguard fasteners, for example). In general, any embodiment of the invention can be constructed to include or be compatible with a closed-end or open-end grip/tube assembly.

It may be desirable to supplement the strength of a rider's forearm for grip rotation by providing additional leverage to the rider in the form of a modified handgrip component. This can be done by increasing the diameters of the outer tube surface and grip so that more torque is created when the handgrip is rotated. However, while effective at creating more torque, this may weaken the rider's grip by forcing the fingers and thumb further apart. According to a study by the United Kingdom Department of Trade and Industry (“Strength Data For Consumer Safety”, United Kingdom Department of Trade and Industry), good thumbtip/fingertip contact may help create the perception of a “strong grip” for most humans. Further, their research suggests that as the diameter of a grip exceeds approximately 40 mm, contact between the average thumb and fingers begins to be lost, creating at least the perception—and, perhaps, the reality—of a weaker grip. Thus, increasing the diameters of the outer tube surface and grip beyond a certain point may be counterproductive and undesirable.

By extending only the leading edge of the grip (and, perhaps, the tube), a rotatable lever can be created which provides the hand and forearm additional leverage and increased ability to produce torque when rotating the handgrip. In other words, an increased radius of the grip/tube cylinder is “extruded” over a relatively small area rather than around the entire handlebar. In general, such modified grips (and, if applicable, tubes) are constructed to provide a leading edge extension which provides leverage at the most effective point of the grip for gaining mechanical advantage. The rest of the grip/tube component is left unchanged: this can advantageously provide the rider with a familiar ergonomic surface over most of the grip while still providing the desired increased leverage.

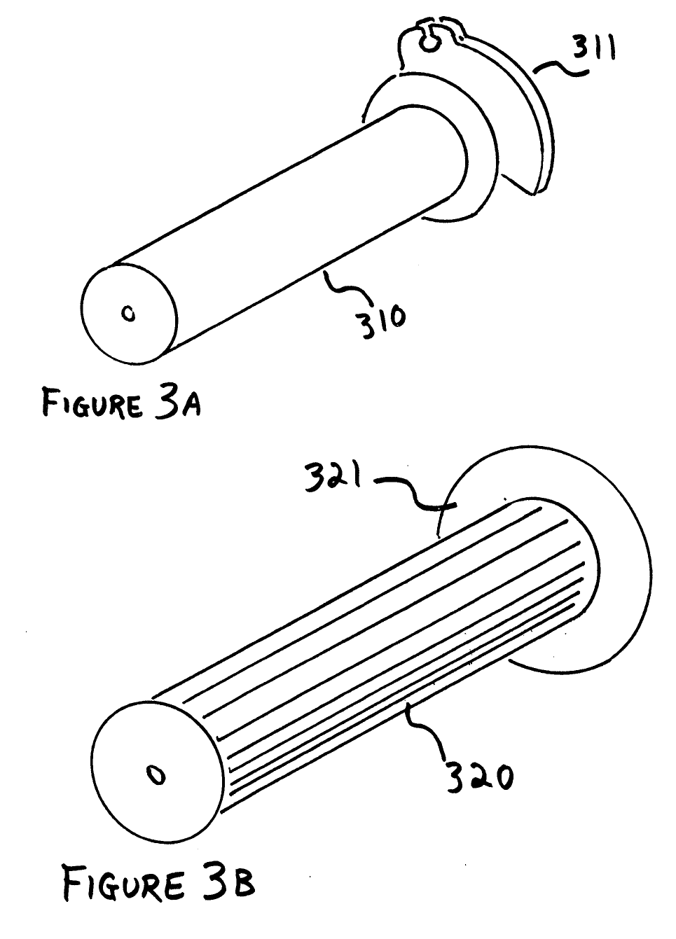

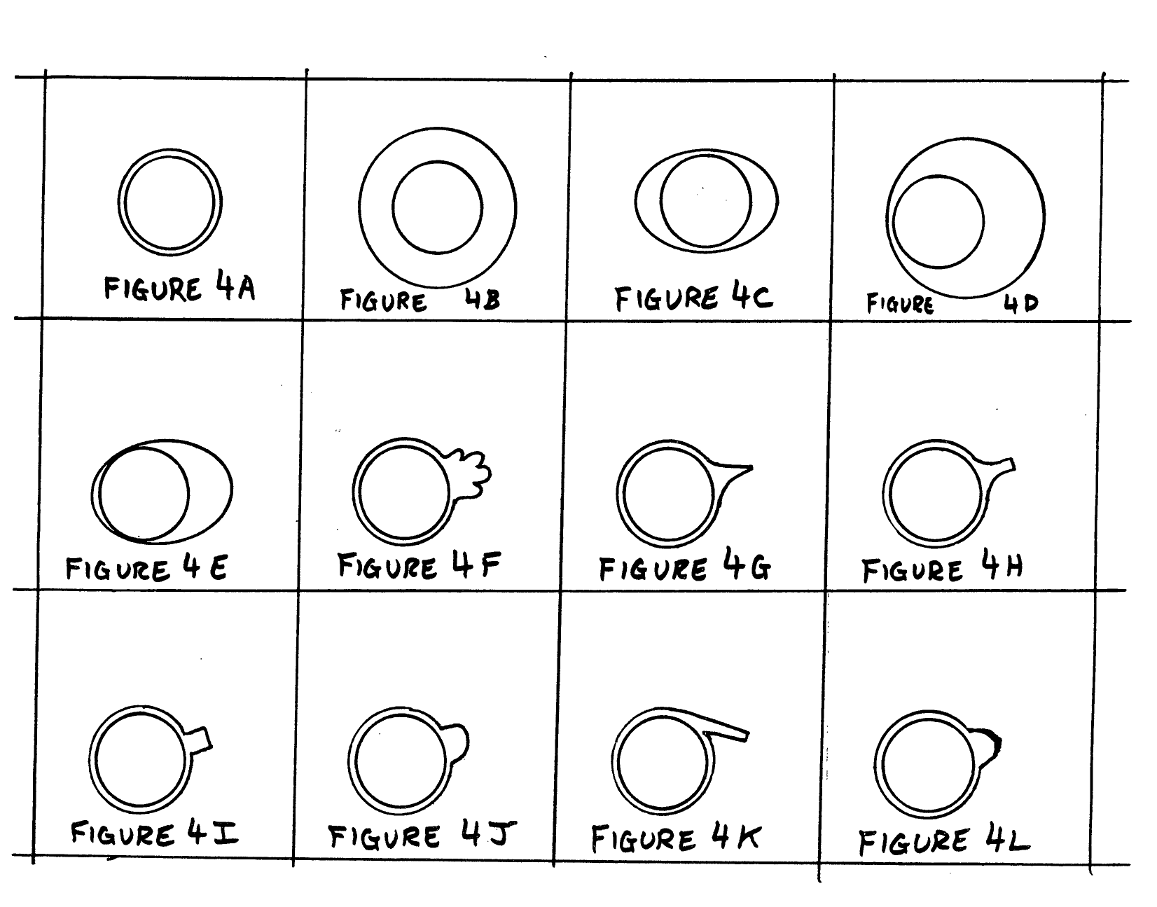

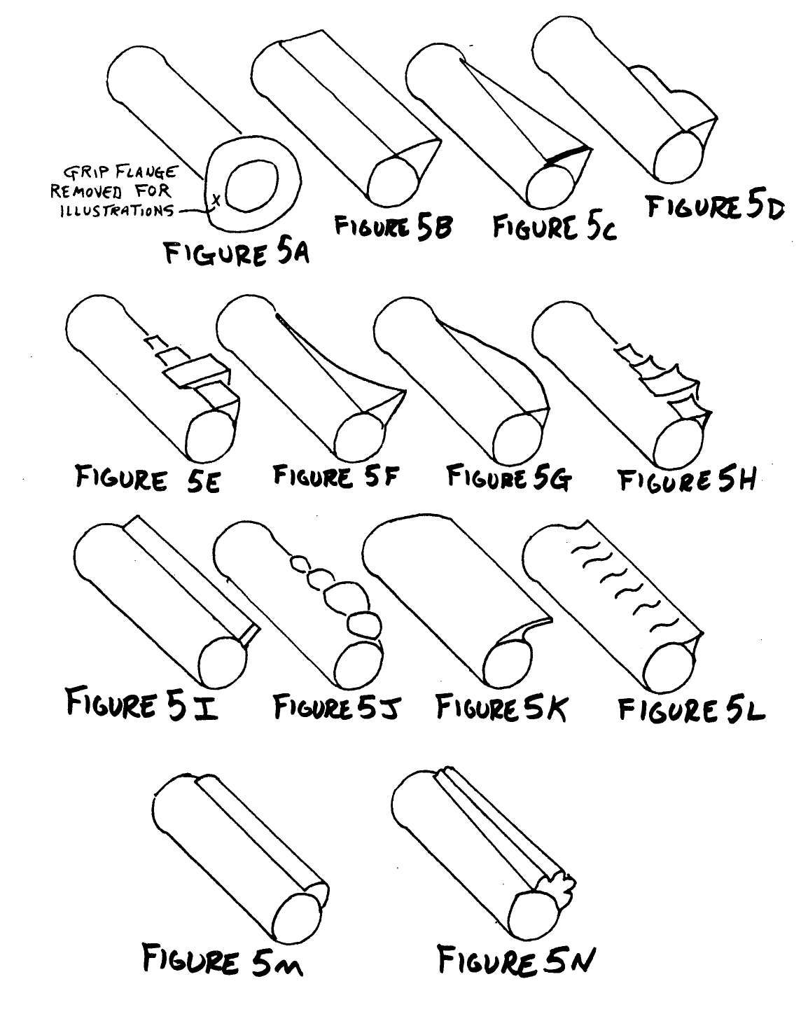

These extensions can be manifested in any of a variety of ways. FIGS. 4A through 4L are each a cross-sectional view of a grip (the outer circumference) mounted on a tube (the interior circle), illustrating a variety of grips that can be used with embodiments of the invention. FIG. 4A illustrates a tube and a conventional grip. FIGS. 4B through 4L illustrate modified grips having a shape other than that of a conventional grip. Similarly, FIGS. 5A through 5N are each a perspective view of a grip (all but FIG. 5A having the stop flange removed, to increase the clarity of the view of the grip) that can be used with embodiments of the invention. FIG. 5A illustrates a conventional grip. FIGS. 5B through 5N illustrate modified grips having a shape other than that of a conventional grip. The modified grips enable a hand to apply increased torque when rotating the grip (and tube on which the grip is positioned). (In FIGS. 4A through 4L and 5A through 5N, rotation of the grip and tube is clockwise and the grips are shown in an unrotated “rest” position. In FIGS. 5A through 5N, the free end of the grip is to the left.) As can be seen, several characteristics occur consistently in the modified grips. The cross section of most of the extensions can be described as a wedge shape, with the wide section of the wedge proximate to the tube and the narrow section or pointed end distal from the tube. The cross section can range from a narrow fin to a round bubble. Many of the extensions in FIGS. 5B through 5N are shaped so that the extension fits nicely within the curled fingers of a gripping hand. The profile of many of the extensions in FIGS. 5B through 5N tends to taper inwardly towards the handlebar as the extension extends toward the free end of the grip. In general, the largest increase to grip (and, if applicable, tube) radius tends to occur beneath the rider's index and middle fingers where the leverage for downforce is greatest and where the thumb can help maintain a good grip. A rider's comfort preferences can determine which manifestation is best for the rider. In fact, some riders may prefer to stick to a traditional handgrip shape and forego the leading edge extensions altogether due simply to the preference for, and availability of, traditional round grips.

3. RHA Tube Flanges: The Stop Flange, Grip Washers, the Rack Flange, and the Locking Flange

As indicated above, the description of RHAs in accordance with the invention is generally made with respect to tubes including a stop flange or around which a grip washer is positioned. A stop flange is useful for guaranteeing that a grip will not slide too far onto the RHA tube and interfere with rotation by rubbing on the RHA housing. A grip washer (or washers) can also be used to ensure that friction between grip and RHA housing will not interfere with rotation.

A rack flange can be used in an RHA according to the invention to mesh with and drive a pinion gear. A rack flange can be viewed as a modified version of a throttle tube's cable flange. A rack flange is a flange with gear teeth formed around a part of the periphery of the flange, e.g., gear teeth formed around a quarter of the periphery of the flange. Where the cable flange pulls a cable to actuate the throttle, the rack flange utilizes gear teeth to turn the pinion gear. When a rack flange is used in an RHA according to the invention, several steps can be taken to ensure satisfactory actuation. First, the tube must be made from materials strong enough to serve as gear teeth. Typically, this means metals such as aluminum or stainless steel. Second, the bore of the tube should be formed so as to accommodate all of the diameter variations among handlebar manufacturers. This can be accomplished by making the tube bore large enough to fit the largest typical diameter and then taking steps to reduce gaps when trying to fit smaller diameters. For example, cylindrical bushing-like shims used at each end of the tube bore can improve a sloppy fit. The fit of the handlebar in the tube can be important since a poor fit may allow movement of the tube on the handlebar, which may cause the rack flange's teeth to not engage the pinion smoothly.

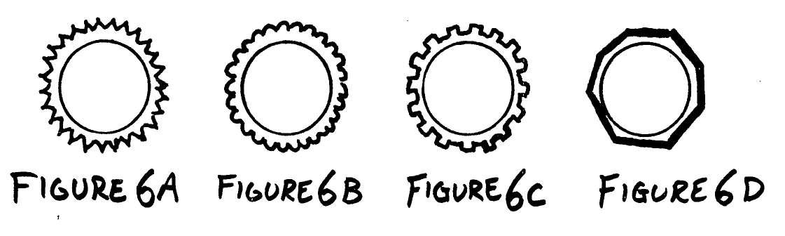

A locking flange and rack wheel can be used instead of a rack-flanged tube in implementing an RHA according to the invention. The locking flange enables the tube to lock into the rack wheel to transmit handgrip rotation to rotation of the rack wheel (and, consequently, actuation of the rest of an RHA according to the invention and the apparatus which the RHA is used to actuate), while remaining easy to disassemble or re-position. The use of a locking flange and rack wheel can provide good performance (e.g., by avoiding the potential problem with a rack flange discussed above) and the description herein of an RHA according to the invention is generally made with respect to use of a locking flange and rack wheel. A locking flange can be constructed so that the perimeter of the locking flange has a regular pattern (some examples of which are illustrated in FIGS. 6A through 6D) which interlocks with a corresponding pattern inside the rack wheel. For example, a locking flange can be formed with a perimeter having a pattern of regularly spaced points (as illustrated in FIG. 6A), small petal shapes resembling hemispheric fingers (as illustrated in FIG. 6B), or gear-like teeth (as illustrated in FIG. 6C). Or, for example, a locking flange can be formed with a perimeter having any number of flat sides of equal length, e.g., a pentagonal, hexagonal (illustrated in FIG. 6D) or octagonal shape. A locking flange having a high “resolution” pattern (larger numbers of regular shapes along the perimeter) provides a high degree of rotational positionability of the tube relative to the rack wheel and housing, which may be desirable for grip/tube embodiments featuring an extended leading edge, since different hands will undoubtedly prefer slightly different positions for the leading edge (which different positions can be achieved by rotating the locking flange into different relative positions with respect to the rack wheel).

4. RHA Tube Options: The Tube Lever and the Thumb Paddle

As described above, leading edge extensions on the grip (and, perhaps, the tube) may provide extra leverage when the rider rotates the grip. However, some riders may prefer to stick to a traditional handgrip shape and forego the leading edge extensions altogether. For these riders, there are other options for creating increased torque for a given rotation of the handgrip.

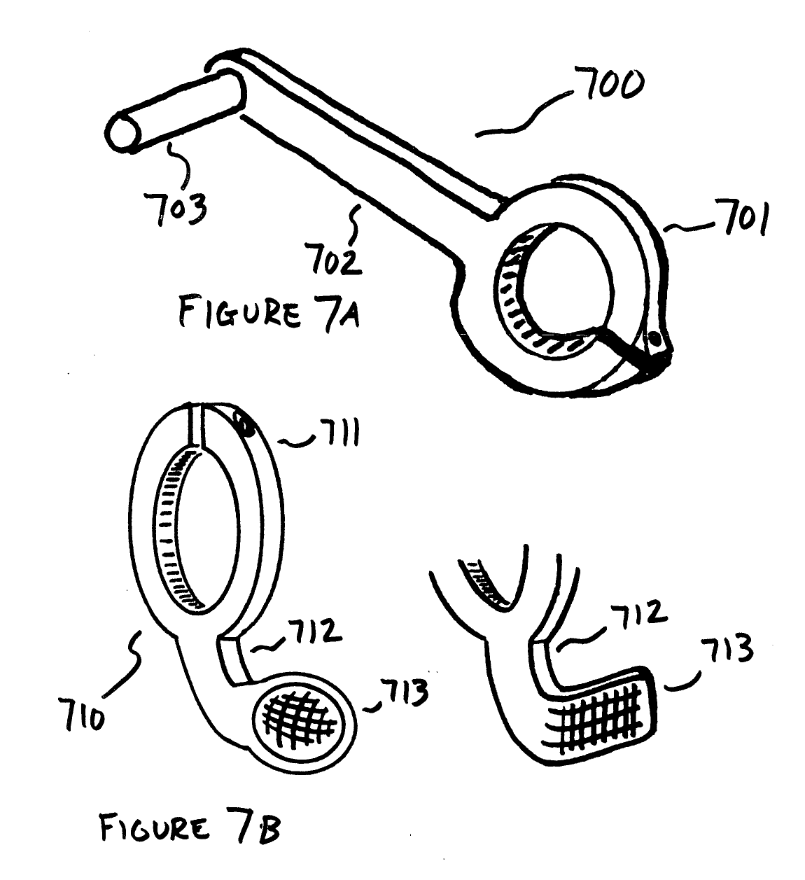

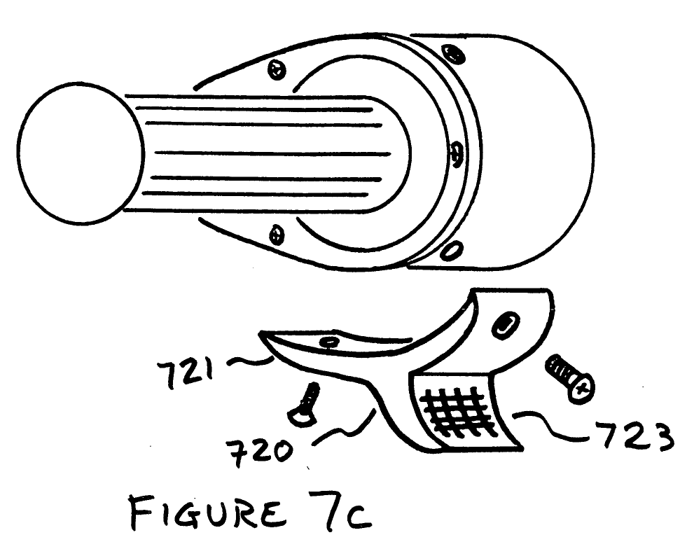

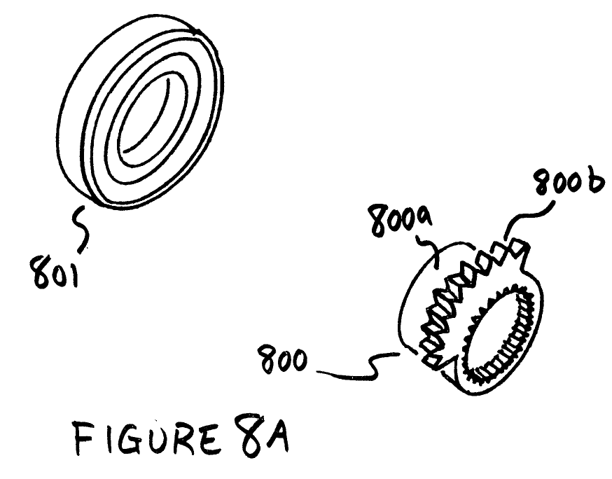

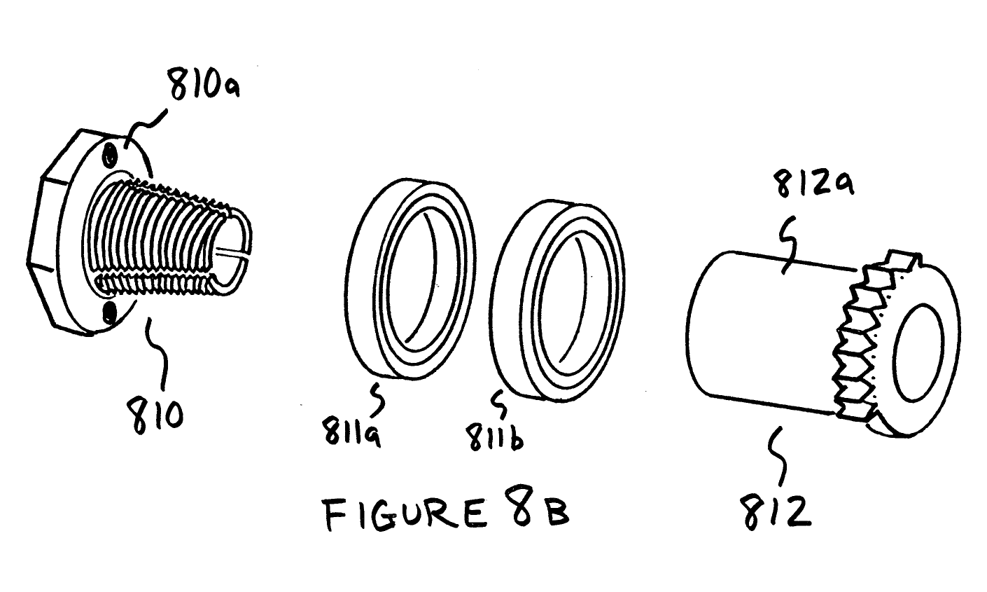

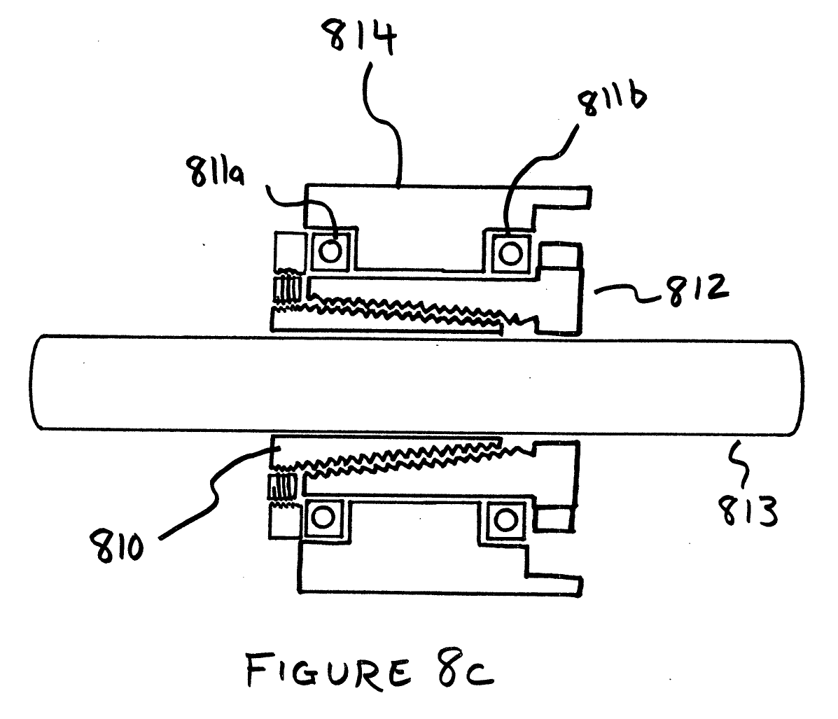

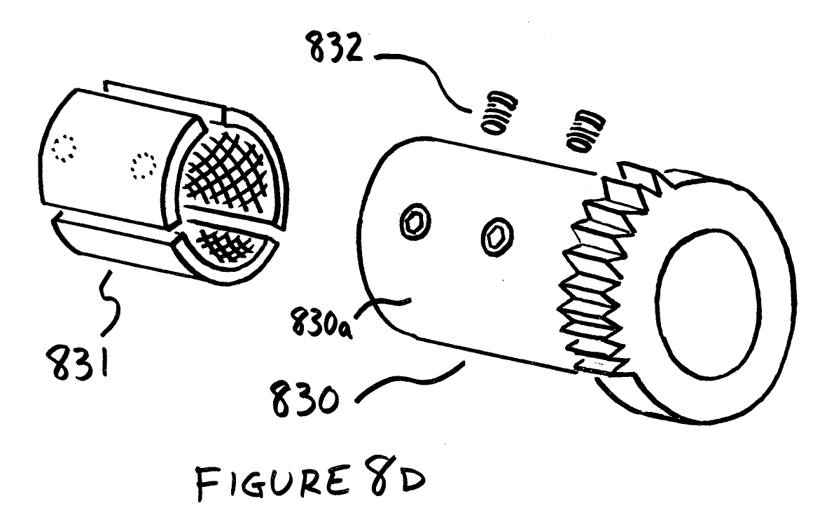

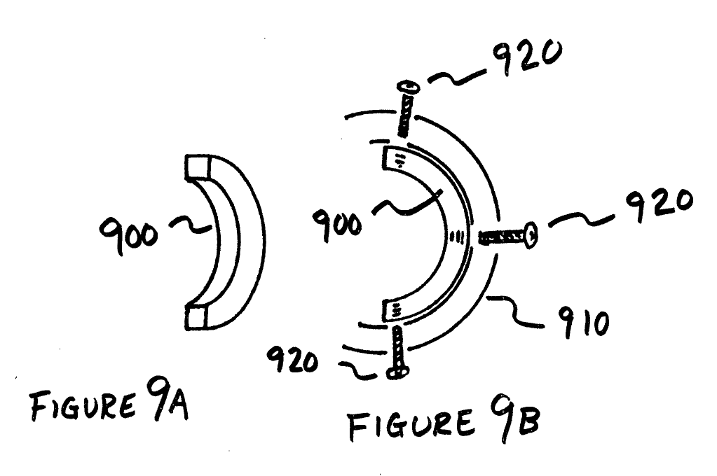

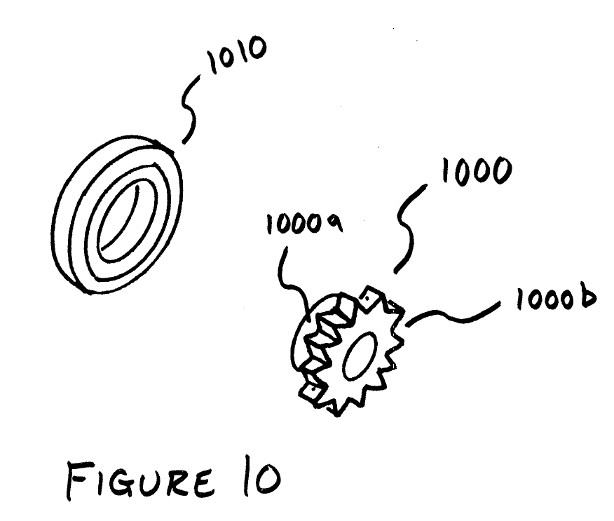

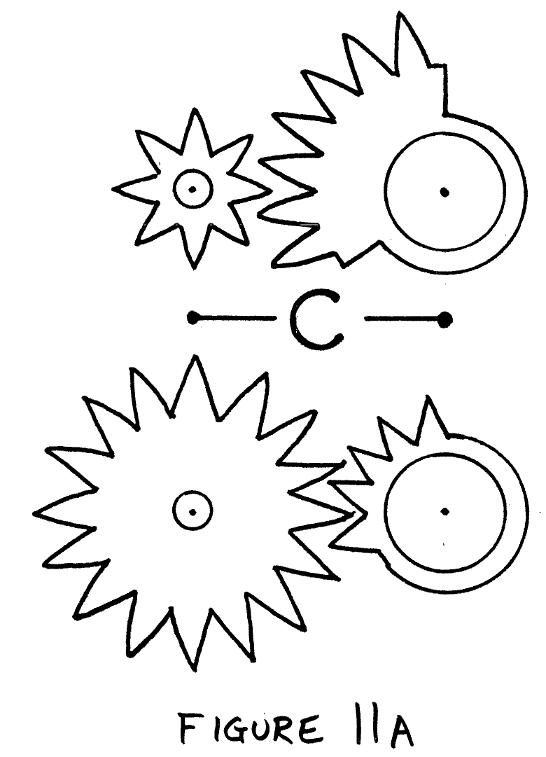

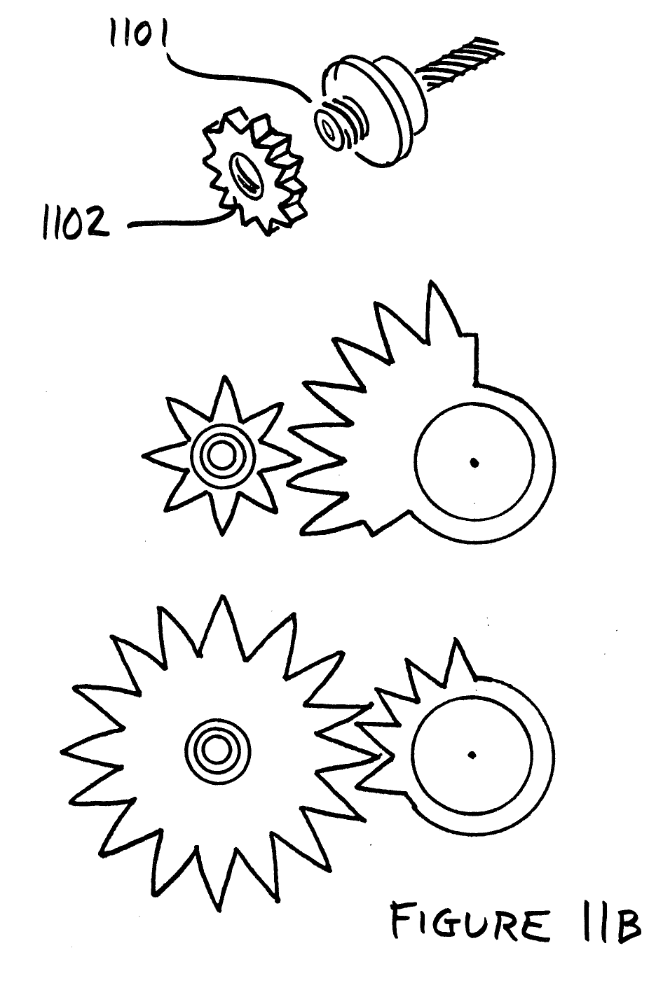

FIG. 7A is a perspective view of a tube lever 700. The tube lever 700 is an extension that can be locked on to a tube in any appropriate manner. For example, a tube lever can be locked onto a section of the tube between a locking flange and a stop flange for tubes that have both flanges. A base 701 of the tube lever 700 encircles the tube (not shown in FIG. 7A) and is locked into place on the tube with an appropriate fastening mechanism, such as one or more pinch bolts. Additionally, an exterior section of the tube and the interior of the tube base 701 can be molded or machined with matching spline teeth or other interlocking shapes such as hexagonal or octagonal sides. The base 701 of the tube lever 700 may be flanked on the right and left with either grip washers or stop flanges to prevent the base 701 from rubbing on the housing.

An extension section 702 of the tube lever 700 protrudes from the base 701 of the tube lever 700. The tube lever 700 can be positioned on the tube so that the extension section 702 protrudes forward in the same direction that leading edge extensions of the grip would. An appendage 703 (tube lever activator) extends from the extension section 702 near the end of the extension section 702 opposite that adjoining the base 701 of the tube lever 700. The appendage 703 is generally parallel with the tube when the tube lever 700 is positioned on the tube and provides a place for the index and middle fingers of a rider to push during rotation of the handgrip. The appendage 703 can be attached to the extension section 702 with a hinge and spring, in manner similar to a folding shift lever, to prevent bending and breaking of the appendage 703 as a result of unintended impact (e.g., such as may occur during a crash).

The extension section 702 can be made long enough to provide more leverage than the grip/tube extensions discussed above. The extension section 702 can also be made short enough so that the extension section 702 does not interfere with a control lever being pulled toward the handlebar. The location of the extension section 702 near the RHA housing can also facilitate ensuring that such interference does not occur, since such location will typically be nearer the hinged part of the lever than the free end of the lever, the former undergoing less travel during actuation of the lever than the latter. When a rider requires extra leverage for rotating the grip, the index finger and/or middle finger can be extended to the top of the appendage 703 and used to force the appendage 703 downward, thereby imparting rotation to the tube lever 700 and, thus, the tube.

The tube lever is adapted to enhance leverage for forward rotation of the handgrip. To enhance leverage for rearward rotation of the handgrip, a thumb paddle can be mounted on the tube. FIGS. 7B and 7C are perspective views of thumb paddles 710 and 720, respectively, that can be used with an RHA according to the invention. The thumb paddle 710 show in FIG. 7B has a construction and operates in a manner similar to that of the tube lever 700. The thumb paddle 710 includes a base 711, an extension section 712 and a thumb paddle activation pad 713. A hole in the base 711 enables the thumb paddle 710 to be mounted on the tube: the mounting can be done in the same manner as described above for mounting the tube lever 700 on the tube. The thumb paddle 710 can be used with RHAs having a stationary housing. The thumb paddle 720 of FIG. 7C can be used with RHAs having a rotatable housing. The thumb paddle 720 of FIG. 7C includes a base 721 that is attached to the rotatable housing. A thumb paddle activation pad 723 is attached to the base 721. For both thumb paddles 710 and 720, the rider pushes down with the thumb on the thumb paddle activation pad 713 or 723 to produce additional leverage in effecting rearward rotation of the handgrip.

5. The Rack Wheel and the Rack Hub: Cylindrical Rack Assemblies

Embodiments of an RHA according to the invention can make use of a “cylindrical rack assembly,” such as a rack wheel or rack hub, described in more detail below, to transmit the rotational control input imparted to the handgrip to mechanisms that convert the rotational motion to translational motion. The terms “rack wheel” and “rack hub” have been used because those apparatus combine the rack from “rack and pinion” with a rotating wheel or hub. A rack wheel or rack hub is differentiated from a full toothed gear since the rack wheel or rack hub only has teeth along a short section of its perimeter. While these partial-perimeter gears are commonly referred to as sector gears in industry, the other features of the rack wheel, described below, warrant a differentiating name.

It is anticipated that the rack (gear teeth) of a cylindrical rack assembly (e.g., rack wheel or rack hub) will likely occupy about a quarter of a circle (e.g., about 90-100 degrees) maximum since that corresponds directly to the average maximum flexion/extension range of the human wrist. The flat ends of the rack serve as stops which limit the rotating range of the cylindrical rack assembly as the flat ends of the rack contact a stop block in the housing. FIG. 9A is a perspective view of a stop block 900 and FIG. 9B is a perspective view of the stop block 900 positioned in a housing 910 of an RHA according to the invention. The stop block 900 is held in place in the housing 910 by set screws 920. As detailed in the tube flange section above, the perimeter of a locking flange is fabricated with a regular pattern of shapes which interlock with a corresponding pattern inset into the bore of a rack wheel.

A rack wheel or rack hub can be made of rust-proof materials such as suitable gear-grade alloys of aluminum, bronze, or stainless steel; the material choice should follow the basic industry practice of being equal to or slightly softer than the pinion material. In addition, external sealed, shielded, and in some cases needle bearings will be used for a rack wheel or rack hub. The bearings encircle the exterior of a hub (as opposed to mounting inside the hub) and press-fit into the RHA housing.

Tooth sizing and rack-to-pinion gear ratios can be based on well-known industry practices for a given application's load and displacement requirements. Exemplary implementations are described in more detail below in the gear ratio section.

FIG. 8 is a perspective view of a rack wheel 800 and an associated bearing 801 that can be used in embodiments of an RHA according to the invention that include a stationary housing. The rack wheel 800 includes a rack 800b and a hub 800a over which the bearing 801 fits.

In the RHAs illustrated in FIGS. 15A and 15C (described further below), the configuration allows the center of the rack wheel to “float” in its bearing around the circumference of the handlebar and thus accommodate the slight variations in diameter from different handlebar manufacturers. The finished diameter of these handlebars can vary by as much as 1.75 mm or 0.069″ due to finishes, coatings and stampings. The “float” allows the rack wheel to remain centered concentrically on the main axis of the handlebar for best rotating action with the tube.

In the RHAs illustrated in FIGS. 15B and 15D (described further below), a rack hub is used. A rack hub is similar to a rack wheel, but has a longer hub which runs the full width of the housing. The hub is fitted externally with two sealed bearings, one recessed into each side of the housing, or one open needle bearing.

In one embodiment of a rack hub, the elongated hub of the rack hub is threaded internally with a tapered tap. A collet lock, a collet-like locking insert with tapered external threads, screws into the threaded bore of the elongated hub and locks the collet lock and rack hub on to the handlebar as the collet lock is tightened into the bore of the elongated hub. FIG. 8B is an exploded perspective view of a collet lock 810, sealed bearings 811a and 811b, and rack hub 812, illustrating the foregoing assembly. The collect lock 810 is threaded into the interior of the elongated hub 812a of the rack hub 812 and clamps on to a handlebar (not shown in FIG. 8B). The bearings 811a and 811b are positioned around the exterior of the elongated hub 812a of the rack hub 812. Set screws (not shown in FIG. 8B) run axially thru the collar 810a of the collet lock 810 in order to prevent loosening of the collet lock 810. FIG. 8C is a cross-sectional view of the collet lock 810, rack hub 812 and bearings 811a and 811b attached to a handlebar 813 within a housing 814. The housing 814 is secured in between and rotates on the two sealed bearings 811a and 811b.

FIG. 8D is a perspective view of a hub lock and rack hub that can be used in embodiments of an RHA according to the invention that include a rotatable housing. The hub lock includes knurled plate sections 831 that fit inside the elongated hub 830a of a rack hub 830. Inside the hub lock, multiple radial set screws 832 press inwardly on the knurled plate sections 831 to lock the rack hub 830 onto the handlebar. This “flush” design features a narrower profile than the collet lock, and affords an option for the housing known as a pivot clamp.

The set screws will likely range in the 4 mm to 6 mm range, be rust-resistant, and be coated with a thread locking compound. The hub can be drilled such that the screws mount only from the top down to prevent loss in the case of loosening. The knurled plates can be made from harder rust-resistant alloys, and can employ a cross-hatched knurling pattern. While not automatically centering itself concentrically like the collet lock, the hub lock can be adjusted very precisely and may accommodate a wider range of handlebar diameters.

6. The Pinion Gear

FIG. 10 is a perspective view of a pinion gear 1000 and an associated pinion bearing 1010 that can be used in embodiments of an RHA according to the invention. The pinion gear 1000 includes a pinion 1000b and a hub 1000a over which the pinion bearing 1010 fits. The pinion gear can be made from relatively strong rust-proof gear-grade alloys such as stainless steel (and, possibly, relatively strong alloys of aluminum for light-duty applications). It may be necessary or desirable for the pinion gear alloy to match the alloy used for the axial screw (described below) since the two will mate in the pinion hub.

External sealed or shielded bearings are used for the pinion bearing(s). The pinion bearing(s) must have a combination of radial and thrust load capability to bear the rotary forces from the rack wheel, and linear push and pull forces from the screw.

Tooth sizing and rack-to-pinion gear ratios can be based on well-known industry practices for a given application's load and displacement requirements. Exemplary implementations are described in more detail below in the gear ratio section.

7. Rack and Pinion Gear Ratios

An RHA according to the invention can be implemented to enable “tuning” for light, medium and heavy actuation loads, e.g., clutch spring loads. Such tuning can be achieved by changing the rack to pinion gear ratio. In practice, this means altering the diameter (or effective diameter, in the case of the rack) of the gears along with the total number of teeth on each gear.

For example, a large rack diameter combined with a small pinion diameter means that a relatively small handgrip rotation will produce a relatively large total push or pull displacement. However, this (desirable) increased output per unit input comes at the cost of greater muscle force required for actuation. Conversely, a small rack diameter combined with a large pinion diameter means that a relatively large grip rotation will produce a relatively small total push or pull displacement. However, this (undesirable) decreased output per unit input comes with the benefit of less muscle force required for actuation. The balance (i.e., the rack to pinion gear ratio) that is chosen for this tradeoff for a particular vehicle (e.g., motorcycle) can be chosen in view of the total actuation (e.g., clutch spring) force to be overcome and the total displacement required to fully actuate a particular apparatus (e.g., engage and disengage a clutch).

Ideally, changes in the rack to pinion gear ratio would not affect the housing, but, in practice, such ratio changes can result in a change of the center distance between the gears' axes. This can necessitate a change to the housing: the housing barrel axis to handlebar axis distance must change. However, for certain prime combinations of diameters and teeth numbers, the center distance will not change, but will remain constant. (FIG. 11A illustrates two different rack to pinion gear ratios with a constant center distance between gear axes.) Use of such a prime combination can be desirable if the prime combination meets the clutch force and displacement requirements, since such a prime combination does not necessitate housing changes.

Regardless of the center distance specifications, the housing gear section can be recessed for the largest practical pinion diameter and largest practical rack wheel diameter. This allows the same housing to accommodate different gear ratios and center distances while using the same side plate. However, if center distance needs to be altered, the pinion axis (housing barrel axis) can be moved away from or toward the handlebar axis, since the pinion axis change will not usually affect side plate specifications.

An RHA according to the invention can be implemented so that the choice of which prime combination to use need not necessarily be made at the time of manufacture of the RHA. By employing a threaded pinion hub 1101 and threaded pinion bore 1102, as shown in FIG. 11B and a lightly press-fit rack wheel/rack hub, a rider can easily change among prime combinations (without need to modify the housing) until he finds a torque magnitude to rotation distance tradeoff which suits him. In general, from 3 to 5 or more prime pairs can be used with the same housing. Changing gears to produce a new prime combination requires some assembly, but common hand tools can do the job easily.

8. The Screw

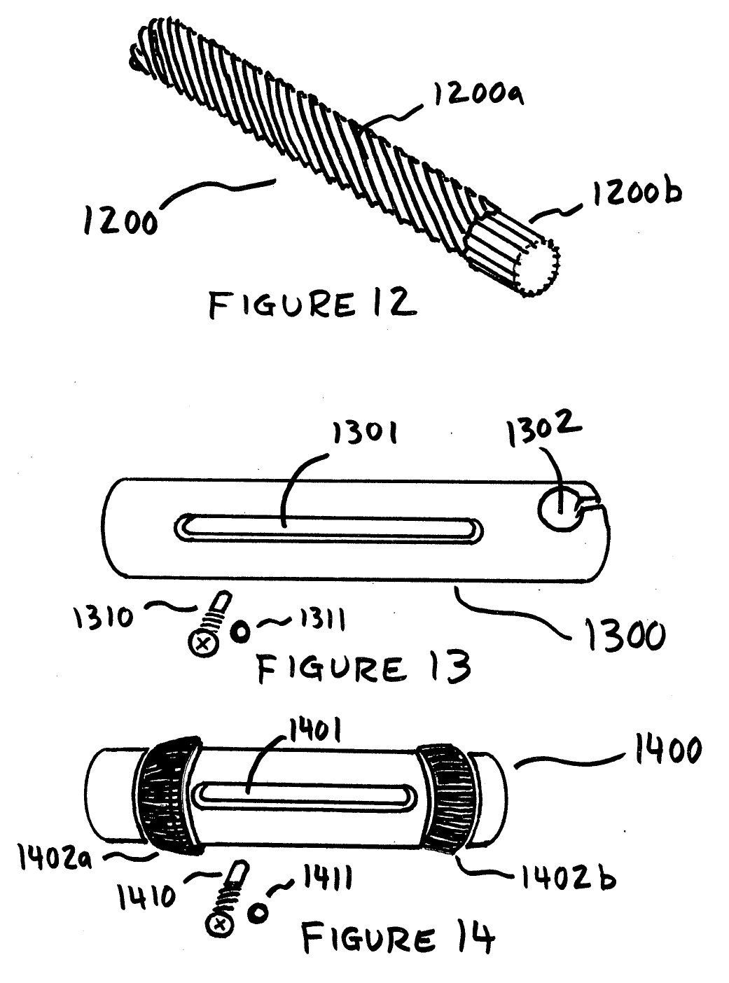

FIG. 12 is a perspective view of a screw 1200 that can be used in an RHA according to the invention. The screw 1200 includes a threaded section 1200a that threads into a coupler or piston (depending on the particular embodiment of the invention) to effect translational movement of the coupler or piston, as described elsewhere herein, and a section 1200b that fits into a hub of a pinion gear and is attached using an industrial adhesive, by soldering, by welding, or using any other appropriate technique. The screw is actually a precision rolled lead screw with multiple threads, not a common bolt. The threads of the screw must be matched precisely by the female threads of the cable coupler or hydraulic piston. Like the pinion gear, the screw can be made from relatively strong rust-proof gear-grade alloys such as stainless steel (and, possibly, relatively strong alloys of aluminum for light-duty applications). It may be necessary or desirable for the screw alloy to match the alloy used for the pinion since the two will mate in the pinion hub to form a stem gear.

The screw's threads have two primary requirements: the threads must be strong enough to withstand the clutch spring forces for long-term use, while the thread pitch must fall into the “overhauling” or “backdriving” class. Whether under a load or not, a normal bolt threaded into a nut won't spontaneously unscrew after being turned with a tool. “Overhauling” or “backdriving” pitch means that a load on the nut or the screw which approaches the line of the screw's axis will cause the nut and screw to rotate spontaneously with respect to each other. In other words, the axial load doesn't stop and lock into place after being turned like a normal nut and bolt. Implementing the screw so that the thread pitch is an overhauling or backdriving pitch allows spring forces to return the RHA grip back to the starting position when the grip is released.

9. The Coupler and the Piston

An RHA according to the invention can be implemented to make use of either a coupler or a piston. The coupler is for use with RHAs for cable-actuation and the piston is for use with RHAs for hydraulic actuation. In both cases, a screw is threaded into a core of the coupler or piston (depending on the particular embodiment of the invention) to effect translational movement of the coupler or piston, as described elsewhere herein.

As indicated above, the female threads of the coupler or piston must match those of the screw precisely. Either of the coupler or piston can be made from relatively strong rust-proof gear-grade alloys such as stainless steel or silicon bronze (and, possibly, relatively strong alloys of aluminum for light-duty applications). It may be necessary or desirable for the coupler/piston alloy to match or be softer than the alloy used for the screw since the two will mate in the coupler/piston core.

FIG. 13 is a side view of a coupler 1300 that can be used with an RHA for cable actuation according to the invention. A guide pin channel 1301 and a cable tip recess 1302 are formed in the coupler 1300. FIG. 13 also shows a guide pin 1310 and associated o-ring 1311.

FIG. 14 is a side view of a piston 1400 that can be used with an RHA for hydraulic actuation according to the invention. A guide pin channel 1401 is formed in the coupler 1400. Two conventional expanding skirt seals 1402a and 1402b are formed at either end of the piston 1400. FIG. 14 also shows a guide pin 1410 and associated o-ring 1411.

Both of the coupler and piston have a guide pin channel. A guide pin threads into an RHA housing at a right angle to the coupler/piston axis of travel. The guide pin tip extends into the coupler/piston's guide pin channel. The head of the guide pin may include an o-ring and o-ring groove for sealing its entrance through the housing. The guide pin channel is machined down the long axis of the coupler/piston's exterior and prevents the coupler/piston from spinning when the screw rotates into the coupler/piston core.

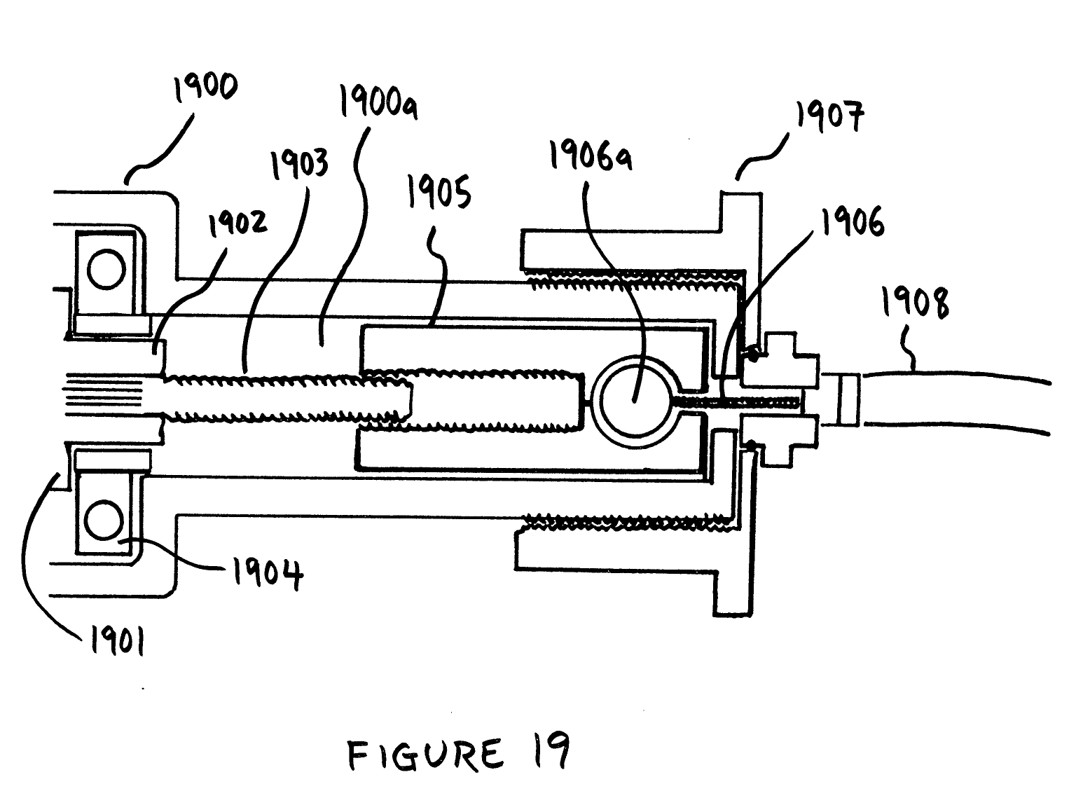

The cable tip recess in the coupler is used to position and retain the tip of a cable (see also FIG. 19). The tip fits into the large round opening while the cable fits into the slot. The cable tip is then held in place by the end f the coupler.

The seals of the piston prevent fluid from exiting the hydraulic reservoir through the core formed in the piston and are discussed in more detail below.

10. The Housing

The particular implementation of the housing can depend on the particular implementation of the RHA. Below, four embodiments of the housing are described: two for cable-actuation (stationary and rotatable housings, illustrated in FIG. 15A and FIG. 15B, respectively) and two for hydraulic-actuation (stationary and rotatable housings, illustrated in FIG. 15C and FIG. 15D, respectively, each of which include hydraulic fluid reservoirs). The housing can be made from, for example, alloys of aluminum (other rust-proof metals may also be used) and can be formed by, for example, machining from billet or casting in a mold and refining with CNC machining.

Each of the four described embodiments of the housing include a separate side plate which seals the rack wheel/pinion area. In the RHAs illustrated in FIGS. 15A and 15C, the side plate locks the tube's locking flange into the core of the rack wheel. In the RHAs illustrated in FIGS. 15B and 15D, the side plate locks the tube's locking flange into itself. The side plate can be of one-piece construction (which can enhance sealing) or multi-piece (e.g., two-piece) construction (which can facilitate assembly). The side plate can include PTFE (Teflon) coating for contact with any articulating surfaces, or a self-lubricating plastic gasket as an alternative. The junction of the side plate with the rest of the housing junction can include an integrated ring gasket or separate rubber gasket for weatherproofing. FIG. 16 is a side view of a two-piece side plate 1600 and associated one-piece gasket 1601 that is positioned between the slide plate and the rest of the housing.

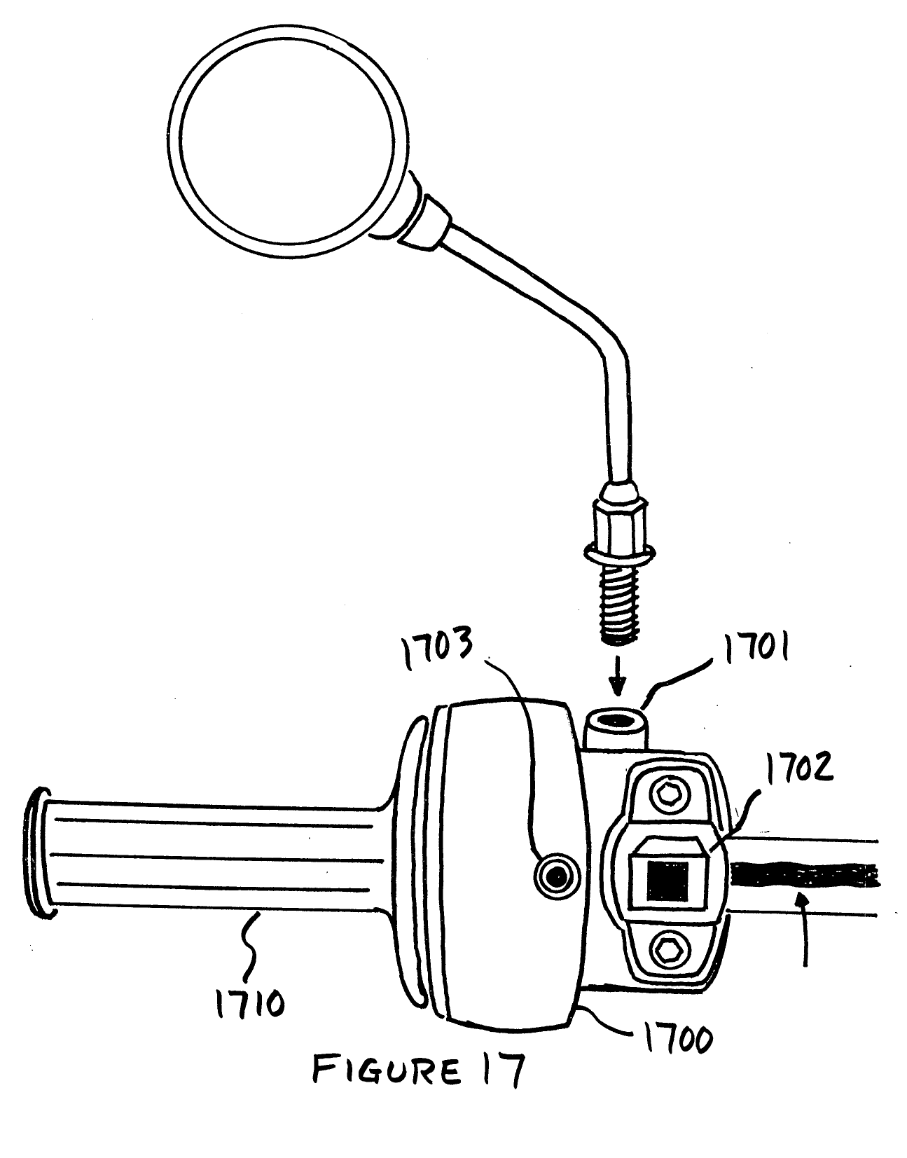

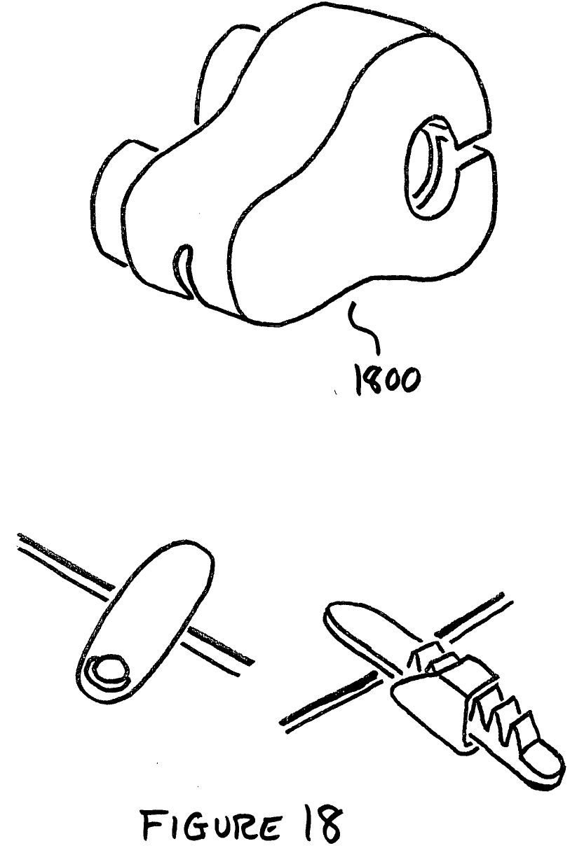

Each of the four described embodiments of the housing can also include one or more options which suit different riding environments and rider preferences. Options for all of the housings include tapped holes for motorcycle mirrors and/or compression release levers. Other options include ignition kill switches machined into the rack wheel area or integrated with the two-bolt clamp. Other electronics, such as position sensors and brake light switches, may also be incorporated. FIG. 17 is a side view of a handgrip 1710 and housing 1700 of an RHA according to the invention, the housing 1700 including a mirror mount 1701, kill switch 1702 and push-button lock 1703.

The gear section of the housing may include an optional pushbutton lock which mates with corresponding hole(s) in the hub of the rack wheel. The pushbutton lock is spring-loaded and can only be pushed in when the grip has been fully rotated so that the corresponding hole(s) in the hub of the rack wheel are aligned with the pushbutton lock. For a C-RHA, the pushbutton lock can be used to fix the clutch in a fully-disengaged position. The pushbutton lock can be implemented so that the lock disengages automatically when the grip is slightly over-rotated. For a B-RHA, the pushbutton lock can be used to lock the brake like a parking brake. For an X-RHA, the pushbutton lock can have one of multiple uses, depending on the type of apparatus that is being controlled.

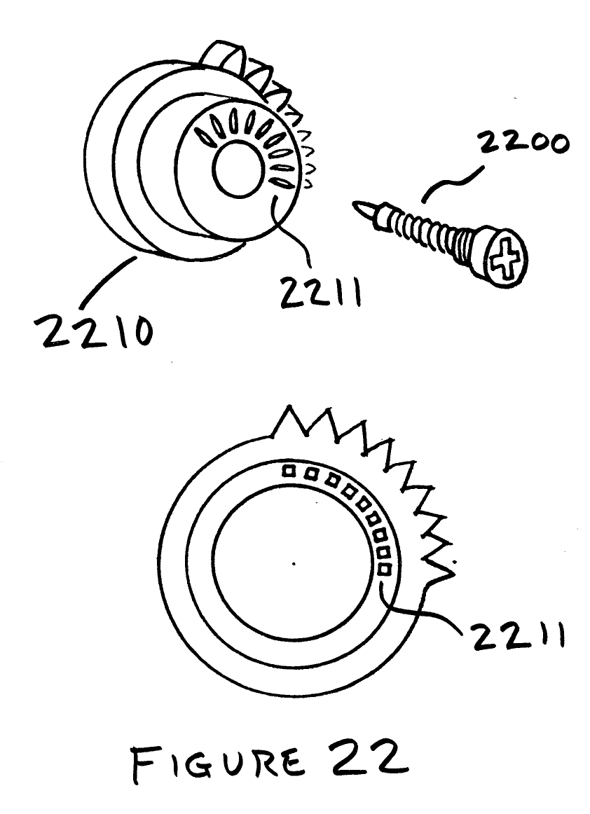

Any embodiment of the housing can be implemented to include haptic feedback. FIG. 22 is a perspective view of a spring-loaded detent 2200 and a rack wheel 2210 having a surface 2211 that has a scored gradation pattern formed thereon to enable the provision of haptic feedback when rotating the handgrip. The spring-loaded detent 2200 is positioned within the housing so that the detent 2200 is forced against the surface 2211 of the rack wheel 2210. As the rack wheel is rotated in response to rotation of the handgrip, the detent passes over the scored surface, providing haptic feedback during rotation of the handgrip. The gradation pattern can be regular or logarithmic to indicate when the extremes of rotation have been reached.

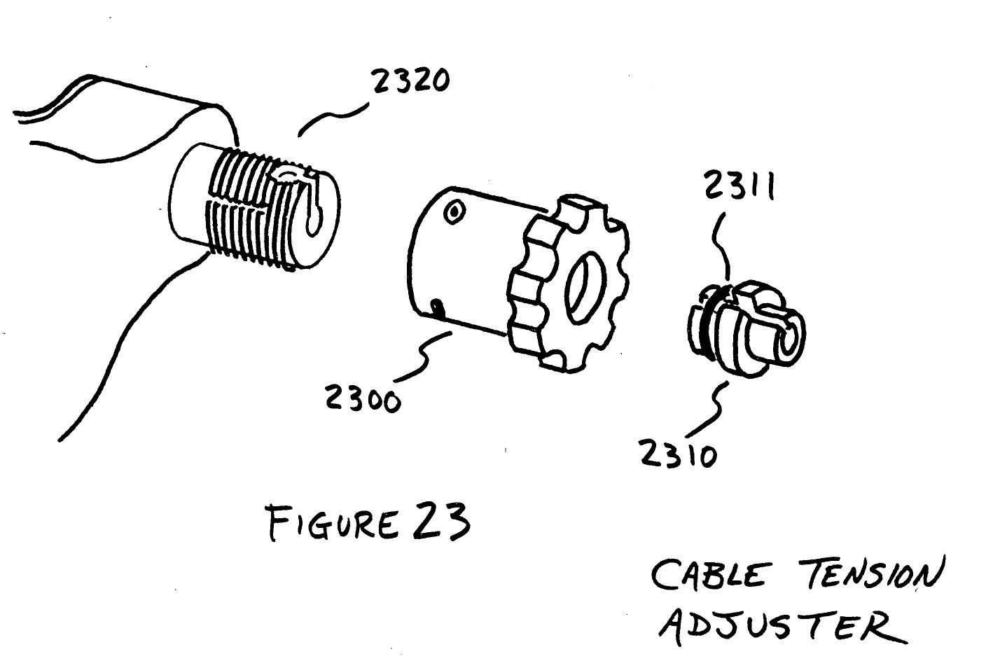

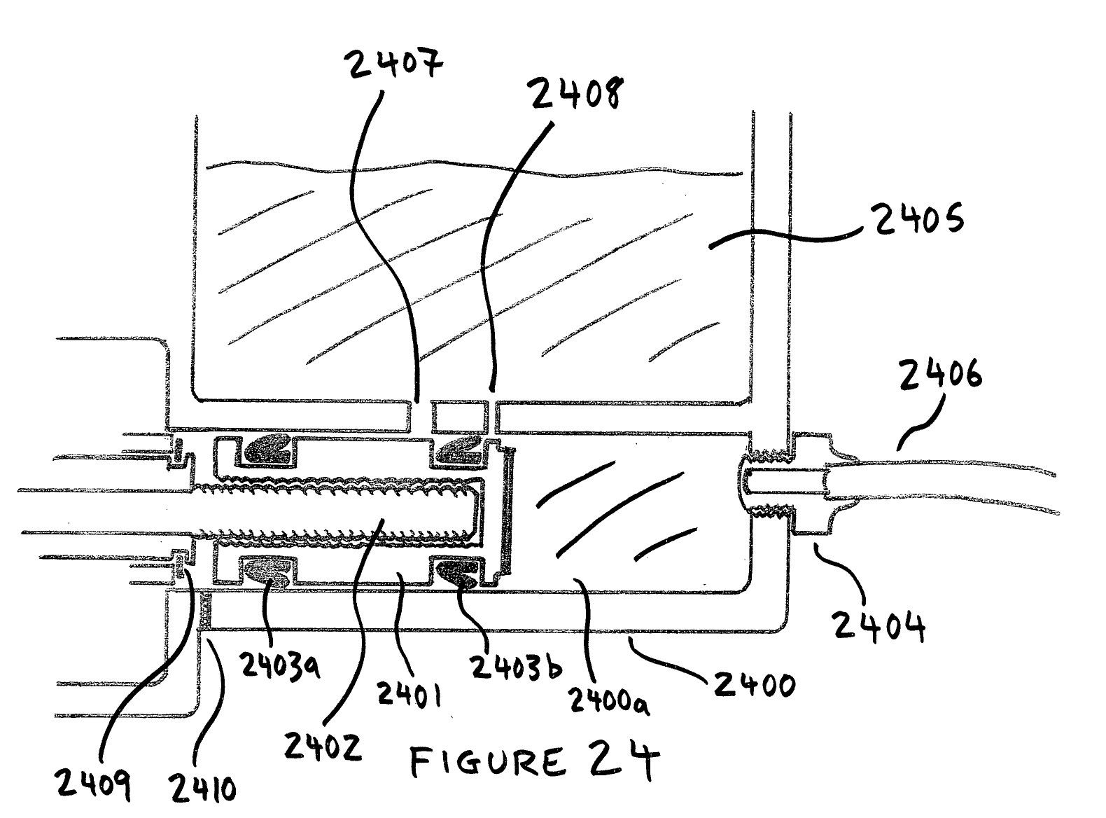

For housings with a coupler for cable actuation, a cable slack adjuster is required. FIG. 23 is a perspective view of a cable tension adjuster 2300 with slotted centering insert 2310 and associated o-ring 2311 that can be used in embodiments of the invention. The cable tension adjuster 2300 threads on to the housing barrel 2320 (see, e.g., FIG. 19). The cable tension adjuster 2300 simply moves the jacket of the cable forward or backward in relation to the steel leader inside in order to remove excess cable slack. The cable tension adjuster 2300 may also utilize spring-loaded detents contacting grooves in the outside of the housing barrel to create an indexed feel and positive locking action as the rider turns the cable tension adjuster 2300.

11. The Accessories

The housing may accommodate several types of accessories depending on the types of controls to be actuated and the type of vehicle with which the RHA is used. Any of a variety of accessories can also be provided; the following are merely exemplary.

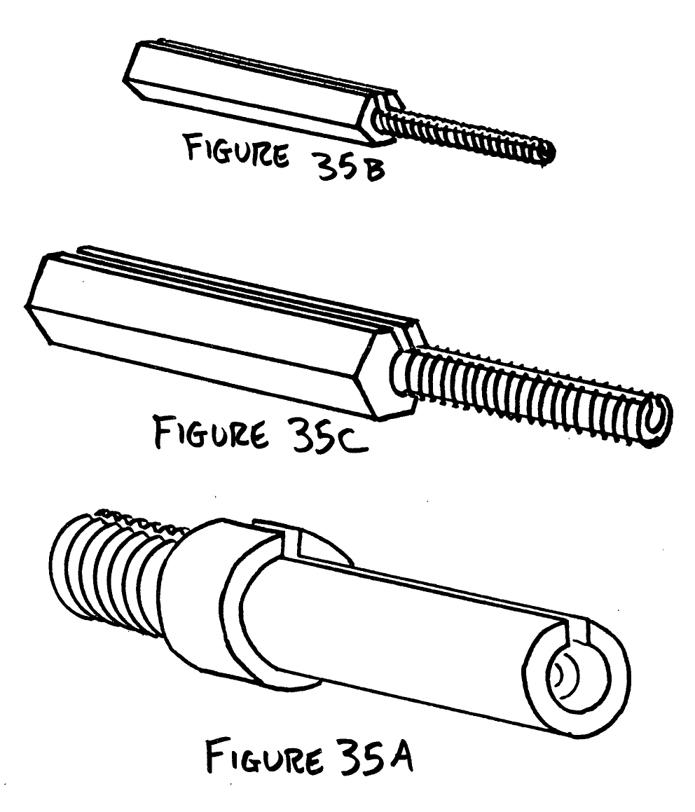

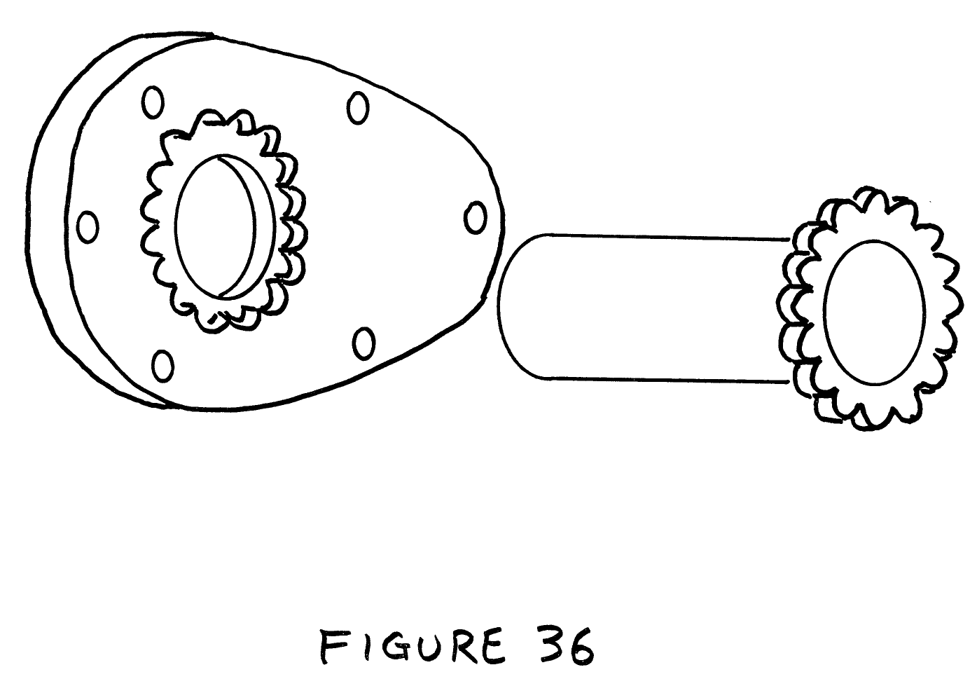

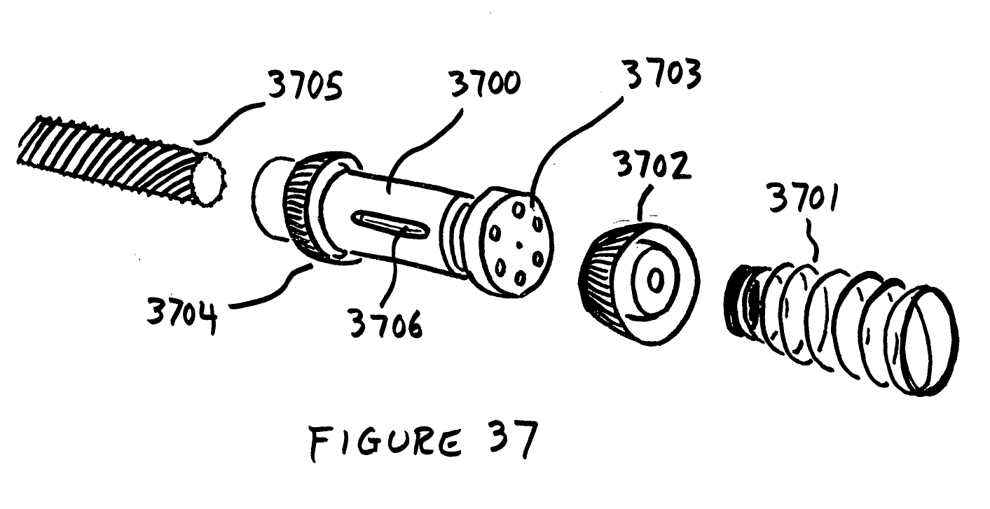

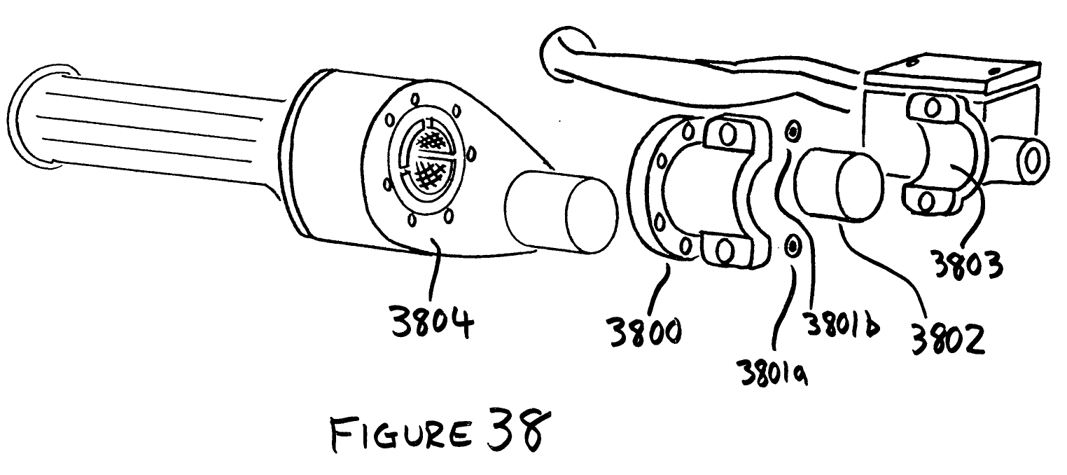

First, for cable actuation, in order to properly fit stock clutch cables, the housing's adjuster needs a component to take up the excess slack (anywhere from 25 mm to 40 mm) in the steel leader of the cable. FIGS. 35A, 35B and 35C are perspective views of three types of cable spacers (jacket lengtheners): a split long-nosed adjuster insert (FIG. 35A), a split mid-cable insert (FIG. 35B) and a split tail addition (FIG. 35C). Each of these cable spacers can be covered with a fitted mudguard for off-road use, if necessary or desirable. Instead of a cable spacer, a custom clutch cable can be used.

For all motorcycles, special fittings for small choke levers are desirable. These can be mounted on the top of the housing for easy thumb or finger access.

For motorcycles with four-stroke engines, special fittings for additional small levers are common. Again, these can be mounted on the housing. Such levers can be used as, for example, compression releases.

For motorcycles with hydraulic controls, special fittings for remote fluid reservoirs may be preferred over the reservoirs which are machined into the housing.

There are three types of leveraging accessories that can be used with a rotatable housing. Two are for forward rotation housings: the finger paddle and the pivot clamp. One is for rearward rotation housings: the thumb paddle. Each is described in more detail elsewhere herein.

12. The Mudguard

A mudguard can be used to cover a RHA according to the invention. The particular implementation of the mudguard can depend on the particular implementation of the RHA. Below, four embodiments of a mudguard are described: two for cable-actuation housings (one for a stationary housing and one for a rotatable housing) and two for hydraulic-actuation housings (one for a stationary housing and one for a rotatable housing). In each of the embodiments, the mudguard is split to wrap over and under the housing at the handlebar. The split is closed on the back side of the housing to secure the mudguard on the handlebar. This can be done using, for example, a built-in rubber fastener. FIG. 18 is a perspective view of a mudguard 1800 and integrated fasteners. The mudguard 1800 is for use with the RHA illustrated in FIG. 15A, i.e., a stationary housing RHA for cable, actuation. In the hydraulic version of the housing, an enlarged mudguard is provided (relative to the size of the mudguard for a stationary housing), with a second split at the bottom of the reservoir/barrel section which can also fasten with a built-in rubber fastener. Rotatable housings may require a slightly-enlarged hole for the collet lock, if used. Materials used for the mudguard can be automotive-grade chemical-resistant and UV light-resistant thermoplastic elastomers and synthetic rubber compounds. The mudguard can also be modified as required to accommodate the accessories discussed above.

### IV. Particular Embodiments of RHA Controls

A. RHA for Cable-Actuated Apparatus

1. Stationary Housing

a. Overview of Construction and Operation

FIG. 15A is a perspective view of a handlebar 1510 on which is mounted an RHA, according to an embodiment of the invention, that can be used with cable-actuated apparatus (e.g., a cable-actuated clutch, in which case the RHA is a C-RHA) and that is housed in a stationary housing 1511 (for convenience, sometimes referred to herein as a “stationary housing RHA for cable actuation”). As explained briefly below and in more detail elsewhere herein, the RHA converts the rotational motion of a hand twisting a handgrip 1512 into the linear pull of a clutch cable (not visible in FIG. 15A, but within the cable sheath 1513). A grip and tube are rotated around the handlebar 1510 by hand. As discussed above, a locking flange of the tube locks into the core of a large diameter rack wheel (as discussed above, a quarter-gear composed of a toothed arc on a cylindrical hub) so that rotation of the grip and tube rotate the rack wheel. Rotation of the rack wheel rotates a corresponding small-diameter pinion gear that mates with the rack wheel. A threaded lead screw extends from a side of the pinion gear into a “barrel” of the housing 1511. Within the barrel, the screw threads into a female coupler. A guide pin channel is formed on an exterior wall of the coupler into which a guide pin is inserted to prevent the coupler from spinning in the barrel, as discussed in more detail above, and a hole is formed in the end of the coupler opposite that into which the screw is threaded to receive the clutch cable tip. Rotation of the pinion gear (and, thus, the screw) by the rack wheel pulls the coupler down the barrel with the clutch cable in tow. The outside of the housing around the barrel is threaded and grooved to mate with a large-diameter cable tension adjuster 1514 (see, e.g., FIG. 23). The entire housing can be covered with a removable mudguard (not shown in FIG. 15A).

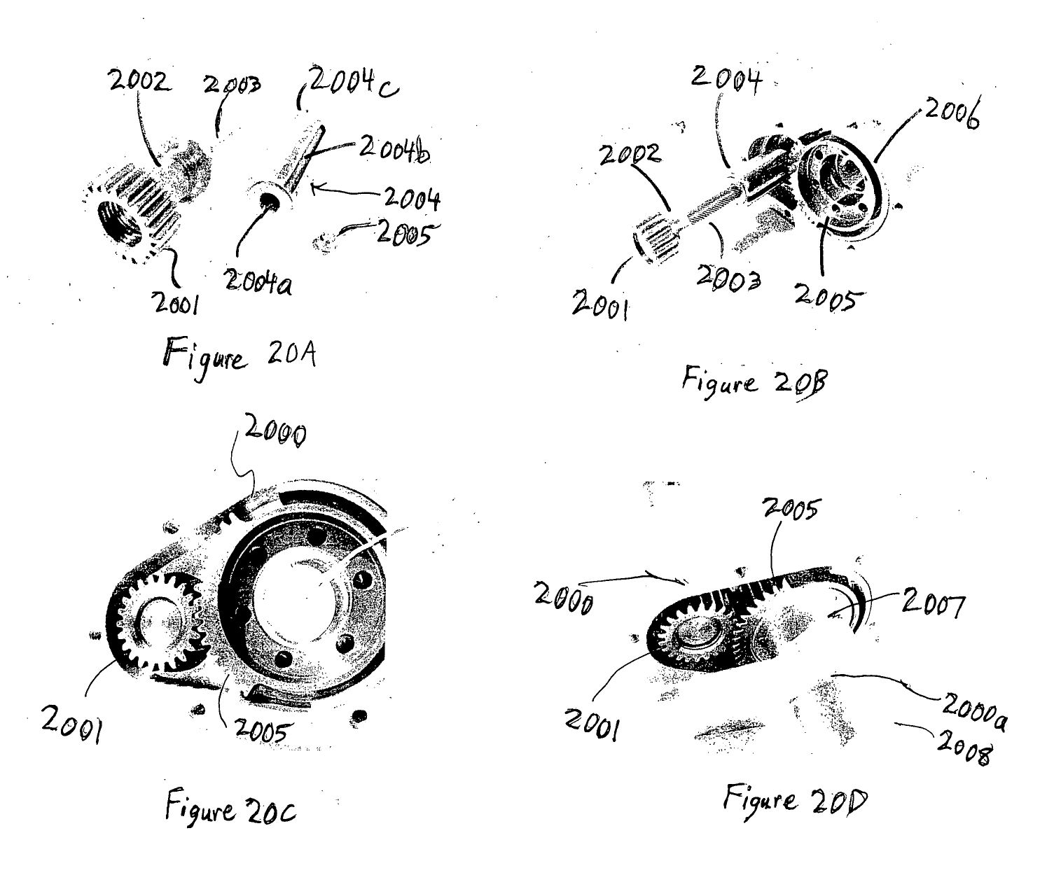

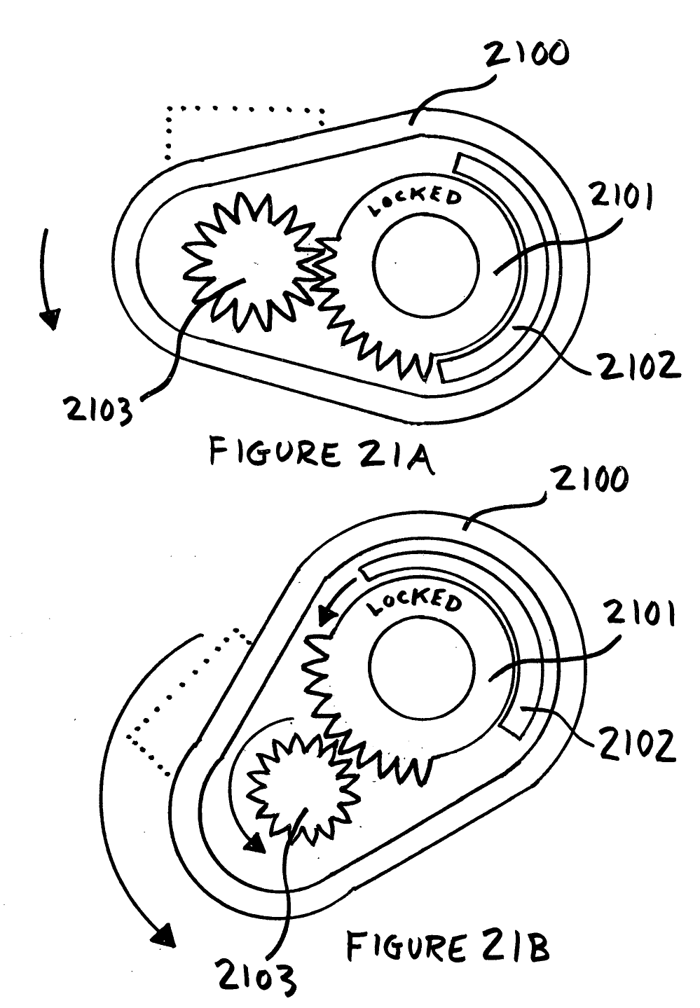

FIG. 19 is a cross-sectional view of part of a RHA for cable actuation, according to an embodiment of the invention, illustrating construction and assembly of parts of a RHA for cable actuation that are enclosed within a housing 1900. (The RHA of FIG. 19 can be implemented in a stationary or rotatable housing.) FIG. 19 shows a pinion gear 1901 from which extends a hub 1902. A screw 1903 extends from the hub 1902. A bearing 1904 is positioned around the hub 1902 to rotatably mount the pinion gear 1901, hub 1902 and screw 1903 in the housing 1900. (A rack wheel which is also positioned within the housing 1900 and mates with the pinion gear 1901 is not shown in FIG. 19, nor is the tube section and locking flange that are also positioned within the housing 1900; however, one or more of these components are visible in FIGS. 20B, 20C and 20D described below.) The screw 1903 extends into a barrel 1900a of the housing 1900 where the screw 1903 is threaded into a coupler 1905 positioned within the housing barrel 1900a. A hole is formed in the end of the coupler 1905 opposite that into which the screw 1903 is threaded. A cable 1906 extends through the hole so that a cable tip 1906a is positioned (via a slot, not visible in FIG. 19, formed in the coupler 1906) in a corresponding recess formed in the coupler 1905. The outside of the housing barrel 1900a is threaded and grooved to mate with a large-diameter cable tension adjuster 1907. Centering insert 1908 is positioned adjacent the cable tension adjuster 1907. The cable extends through coaxial holes in the coupler 1905, housing 1900 and cable adjuster 1907 into a cable sheath 1908 through which the cable connects to further apparatus to enable actuation of the apparatus being controlled with the RHA.

FIGS. 20A through 20D are photographs showing perspective views and a side view of part of a stationary housing RHA for cable actuation, according to an embodiment of the invention, illustrating construction and assembly of the RHA. In FIG. 20A, a pinion gear 2001 having a threaded hole formed therethrough is shown prior to being threaded on to a threaded section of a hub 2002 from which a screw 2003 extends. Also in FIG. 20A, a coupler 2004 and guide pin 2005 are shown. During assembly of the RHA according to this embodiment of the invention, the screw 2003 is threaded part way into the threaded hole 2004a formed in the coupler 2004, and the tip of the guide pin 2005 is fitted into the guide pin channel 2004b formed in the coupler 2004. (The guide pin 2005 can be attached to the housing as described above.) A cable tip receptor hole 2004c is also just visible in FIG. 20A at the end of the coupler 2004 opposite that into which the screw 2003 is threaded. In FIG. 20B, the pinion gear 2001 has been threaded on to the threaded section of the hub 2002, the screw 2003 has been threaded into the coupler 2004, and coupler 2004 is partly inserted into a corresponding recess in a housing 2000. (A bearing that fits around the section of the hub 2002 extending from the pinion gear 2001—see, e.g., the similar bearing 1904 in FIG. 19—is not shown.) A rack wheel 2005 is inserted into an adjacent recess in the housing 2000. A stop block 2006 is attached to the housing 2000 in that recess. The stop block 2006 limits the rotation of the rack wheel 2005 via contact between ends of the stop block 2006 and corresponding ends of the gear-toothed section of the rack wheel 2005. The side view of FIG. 20C shows the assembled pinion gear 2001, hub 2002, screw 2003 and coupler 2004 fully inserted into the corresponding recess of the housing 2000. Similarly, the rack wheel 2005 is shown fully inserted into the corresponding recess of the housing 2000. As can be seen, the teeth of the pinion gear 2001 mesh with the teeth of the rack wheel 2005. Finally, FIG. 20D shows a handlebar 2007 inserted into the rack wheel 2005 and a grip 2008 prior to attaching a side wall 2000a to the remainder of the housing 2000 to enclose the above-described components.

b. Components

i. Grip and Tube

The grip can be manufactured from any of several grades or combinations of thermoplastic elastomers or synthetic rubbers as is common for grips produced by companies such as Scott, Renthal, and Pro-Grip. The grip can be manufactured closed or open-ended to suit different handlebar configurations. The grip can also be manufactured in different shapes and sizes: oversized diameters give the hand extra leverage for rotation as do extruded leading edges as described above. The grip can also include internal grooves or molding which assist in preventing the grip from slipping on the tube and also direct how the grip and tube align longitudinally and rotationally.

The tube can be manufactured from any of several grades of suitable high-strength plastics, composites, or metals as is common for tubes produced by companies such as Pro Grip, Motion Pro, Moose Racing, and Pro Circuit. The tube can be manufactured closed or open-ended to suit different handlebar configurations. The tube can also be manufactured in different shapes and sizes: lengths can be varied for different applications and extruded leading edges can be molded or machined-in for extra leverage as described above. The tube may also include external grooves or molding which assist in preventing the grip from slipping on the tube and also direct how the grip and tube align longitudinally and rotationally.

Embodiments of the tube can include stop flanges or require grip washers to prevent grip/housing friction. Many embodiments of the tube include a locking flange. The locking flange allows the grip and tube to lock into the rack wheel (for a stationary housing) or side plate (for a rotatable housing) to effect the desired actuation while remaining easy to disassemble or re-position. The perimeter of the locking flange can be fabricated with a regular pattern of shapes which interlock with a corresponding pattern inside the rack wheel or side plate.

Finally, grip and tube may be molded together permanently as in the Pro-Grip SCS design. However, ease of grip replacement has kept grip and tube separate for most manufacturers.

ii. Tube Lever

As described above, a tube lever or thumb paddle for increasing leverage can be applied to forward-actuating or rearward-actuating, respectively, embodiments of the RHA illustrated in FIG. 15A.

iii. Rack Wheel

The rack wheel includes a curved rack occupying about one quarter of the perimeter of a bearing-mounted hub. The hub can be overbored to slip over a variety of handles and handlebars (there are slight variations among manufacturers). The hub's exterior is machined as a cylinder to mate with a corresponding large bore bearing. The bearing fits around the hub directly beside the curved rack. The assembly is press-fit into the bearing recess of the housing.

The rack wheel fits into a specially-recessed section of the housing. This section protects the rack and pinion as well as limits the rotational travel of the rack wheel to a maximum of 90 to 100 degrees with a stop block. Other maximum amounts of rotation can be used: some embodiments may include maximum rotations of as little as 30 to 40 degrees of travel.

The rack includes teeth which mesh with matching teeth on the pinion gear. While it is anticipated that straight-cut spur gear teeth are most likely to be used for the rack wheel and pinion gear, bevel cuts and other cuts can be used for applications requiring non-orthogonal fits. Tooth width can range between, for example, 5 mm (or about 5 mm) to 10 mm (or about 10 mm) with, for example, an average module of 1.0 (or diametral pitch of around 24) and a 20 degree pressure angle. Variations in pitch circle diameter, width, cut, module/diametral pitch, and materials will arise as a function of load and displacement requirements. (Note that certain tooth cuts—e.g., bevel cuts—for rack wheel/pinion gear combinations may create axial thrust forces which will require securing mechanisms such as internal or external snap rings or circlips; these are described elsewhere herein.) As described above, the rack wheel may be part of a prime pinion/rack gear pair, and may also be machined on an inner face with a pattern of grooves for haptic feedback.

iv. Pinion Gear

The pinion gear can be a small, fully-formed gear with a machined bore and a solid hub band or perimeter. During operation of the RHA, the pinion gear is turned by the rack wheel. The pinion gear fits into a specially-recessed section of the housing which protects the pinion gear and rack wheel. The pinion hub extends further into the barrel section of the housing. The pinion hub's exterior can be machined as a cylinder to mate with a corresponding sealed bearing. The bearing, which can be selected for ability to handle both radial and thrust loads, fits around the hub directly beside the toothed pinion. The assembly is press-fit into the barrel section of the housing. The bore of the hub can be machined to match the tip of the screw shaft (see, e.g., FIG. 12): the machining can mean tapping the bore to match the screw's threads or both the hub and screw shaft can be machined with traditional straight splines. The hub/screw joint can be joined with industrial adhesive, soldered, or welded for maximum strength. Alternatively, the pinion and screw can be machined from one solid piece of metal; however, the expense and waste involved may make this undesirable.

The pinion includes teeth which mesh with matching teeth on the rack wheel. While it is anticipated that straight-cut spur gear teeth are most likely to be used for the rack wheel and pinion gear, bevel cuts and other cuts can be used for applications requiring non-orthogonal fits. Tooth width can range between, for example, 5 mm (or about 5 mm) to 10 mm (or about 10 mm) with, for example, an average module of 1.0 (or diametral pitch of around 24) and a 20 degree pressure angle. Variations in pitch circle diameter, width, cut, module/diametral pitch, and materials will arise as a function of load and displacement requirements. (Note that certain tooth cuts—e.g., bevel cuts—for rack wheel/pinion combinations may create axial thrust forces which will require securing mechanisms such as internal or external snap rings or circlips; these are described elsewhere herein.) As described above, the pinion may be part of a prime pinion/rack gear pair.

An alternative version of the pinion and hub includes a threaded pinion bore with a matching threaded hub extension. (This is illustrated in FIG. 20A.) Use of a threaded hub extension enables a variety of pinions to be used with the hub and, in particular, pinions that are from a set of “prime” pinion/rack gear pairs with a constant center distance.

v. Screw

The screw is an important part of an RHA according to the invention, since the screw is where rotary and linear forces intersect. As indicated above, the screw is actually a precision lead screw.

As discussed in the pinion section, the hub of the pinion can be machined to match the inserted section of the screw (see, e.g., FIG. 12). Machining can be straight splines, or just the matched threading of the screw itself. The pinion hub/screw joint can be joined with industrial adhesive, soldered or welded for maximum strength.

An important aspect of the screw is the screw's thread specifications. The threads must be strong enough to withstand axial forces associated with the actuation (cable or hydraulic). In addition, the thread pitch must fall into the overhauling or backdriving class. As described above, overhauling means that the forces of the load will cause the screw to rotate spontaneously. For clutch controls, this means that the spring forces of the clutch will cause a C-RHA grip to return to its start position when released.

As thread pitch increases for a given screw, space is created for additional threads or “starts.” Screws with overhauling or backdriving specifications usually have multiple starts: thread pitch, thread size, and screw diameter combine to determine the maximum number of starts. It is anticipated that total starts for a C-RHA according to the invention will range between 4 and 20. For a C-RHA, the “lead” of the screw must also be defined. The lead is the displacement, distance, or travel resulting from one revolution of the screw. On average, the length of cable pull required to move a clutch from fully engaged to fully disengaged is about 8 mm to 10 mm. Note that this distance is significantly less than the total pull of a typical clutch lever on the cable: the typical clutch lever will move a cable 16 mm to 20 mm. This is roughly a 2× difference. The difference is to allow for freeplay and overpull. For a conventional clutch lever control, freeplay is the slack that gets taken up as the lever first starts to move (before significant resistance is felt). Overpull is the movement of the lever towards the handlebar that is felt well after the clutch has been fully disengaged. Freeplay and overpull are critical to proper adjustment of the clutch. Together, freeplay and overpull provide a margin of safety to account for factors such as cable stretch, clutch plate expansion due to heat, clutch plate wear, and misadjustment of the clutch by the rider. However, given several millimeters of both freeplay and overpull buffer, the total cable travel still does not add up to the 16 to 20 mm provided by the typical clutch lever: there is extra freeplay and extra overpull designed into the typical lever pull.

The extra freeplay is given for finger contraction to reach a point where maximum muscle forces can begin to act on the lever. This is especially important for smaller hands with shorter fingers. However extra freeplay is not a factor for C-RHA mechanisms as the finger position is fixed on the grip. There is also extra overpull. Presumably, extra overpull is provided to account for extra-thick grips or lever damage due to a crash which would shorten the total travel of the normal lever. This is not a factor for C-RHA mechanisms, either. The “extras” can be traded for additional mechanical advantage. Consequently, the average screw pull for C-RHA mechanisms is about 12 mm (one turn of the grip will move the coupler and cable about 12 mm).

vi. Coupler

As described above, the female coupler is machined internally to match the threads of a precision lead screw. The coupler can be made from relatively strong rust-proof gear-grade alloys such as stainless steel, silicon bronze, (and, possibly, relatively strong alloys of aluminum for light-duty applications). It may be necessary or desirable for the coupler alloy to match or be softer than the alloy used for the screw since the two will mate in the coupler core.

The coupler links the cable to the RHA. The coupler is threaded internally with threads which match the screw. This threaded bore of the coupler may include an oil-hole at its blind end. To prevent rotation of the coupler in the housing barrel, the external surface of the coupler can be machined along the long axis of the coupler to form a guide pin channel into which a guide pin is inserted. The coupler has a diameter (about 17 mm minimum for motorcycle clutch cables) which precisely fits the housing barrel with allowances for lubrication. The length of the coupler is determined by the total screw travel required for a given cable pull. The tip of the coupler can be machined with receptor hole (e.g., an an 8 mm×10 mm receptor hole) to house the cable tip.

vii. Stationary Control Housing and Options

As described above, the housing can be made from alloys of aluminum (other rust-proof alloys like magnesium could also be used) and may be machined from billet or cast in a mold and refined with CNC machining. Possible finishes for the housing include anodizing, clear-coating, powder coating, paint, and combinations of these.

The housing for the RHA illustrated in FIG. 15A includes two main sections: the gear section and the barrel section. The gear section, which can also be referred to as the rack wheel/pinion section, mounts on the handlebar so the gears are perpendicular to the handlebar. The barrel section extends parallel to the handlebar. A separate clutch cable adjuster, which is oversized for on-the-fly adjustment, attached to the end of the barrel section opposite the end that is adjacent the gear section. The adjuster can also include spring-loaded detents which snap into grooves machined across the barrel's exterior threads. The adjuster includes a removable core which pops out to allow the clutch cable tip to insert through the adjuster and into the barrel and coupler (see FIG. 23).

The housing can be secured to the handlebar by, for example, a traditional, two-bolt clamp or a collet lock (which is a short, tapered, collet-like threaded insert with axial set screws to prevent loosening). The clamp is traditional and inexpensive, but cannot center the housing concentrically on the center axis of many handlebars due to slight variations in handlebar diameter. The collet insert can center the housing mechanism, but is slightly more expensive to produce.

Each of the described embodiments of the housing include a separate side plate which seals the gear section. The plate locks the tube's locking flange into the core of the rack wheel. The side plate can be of one-piece construction (which can enhance sealing) or multi-piece (e.g., two-piece) construction (which can facilitate assembly). The side plate can include PTFE (Teflon) coating for contact with any articulating surfaces, or a self-lubricating plastic gasket as an alternative. The side plate/housing junction can include an integrated gasket for weatherproofing.

As indicated above, each of the embodiments of the housing can also include one or more options which suit different riding environments and rider preferences, such as tapped holes for motorcycle mirrors and compression release levers, or switches (such as ignition kill switches) machined into the rack wheel area or integrated with the two-bolt clamp.

Finally, the gear section of the housing may include an optional spring-loaded detent for haptic feedback and an optional pushbutton lock which mates with corresponding hole(s) in the hub of the rack wheel. The pushbutton lock is spring-loaded and can only be pushed in when the grip has been fully rotated so that the corresponding hole(s) in the hub of the rack wheel are aligned with the pushbutton lock. For a C-RHA, the pushbutton lock can be used to fix the clutch in a fully-disengaged position. The pushbutton lock can be implemented so that the lock disengages automatically when the grip is slightly over-rotated.

viii. Mudguard

The mudguard can be slipped on to the housing from the barrel side of the housing. The mudguard can be split to wrap over and under the housing at the handlebar. The split can be closed on the back side of the housing with a built-in rubber fastener. The cable adjuster screws on to the housing barrel after the mudguard is in place and mates with an accordion-like boot which protects the adjuster/housing joint even as the adjuster is turned in or out. A separate mud-boot (much smaller than the mudguard) can be used to protect the clutch cable/adjuster joint. Materials used for the mudguard can be automotive-grade chemical-resistant and UV light-resistant thermoplastic elastomers and synthetic rubber compounds. The mudguard can also be modified as required to accommodate the accessories discussed above.

2. Rotatable Housing

a. Overview of Construction and Operation

FIG. 15B is a perspective view of a handlebar 1510 on which is mounted an RHA, according to an embodiment of the invention, that can be used with cable-actuated apparatus (e.g., a cable-actuated clutch, in which case the RHA is a C-RHA) and that is housed in a rotatable housing 1521 (for convenience, sometimes referred to herein as a “rotatable housing RHA for cable actuation”). As explained briefly below and in more detail elsewhere herein, the RHA converts the rotational motion of a hand twisting a handgrip 1512 into the linear pull of a clutch cable (not visible in FIG. 15A, but within the cable sheath 1513). As will be appreciated from the following description, many aspects of the construction and assembly of a rotatable housing RHA for cable actuation are the same as, or similar to, those of a stationary housing RHA for cable actuation. A grip, tube and the rotatable housing 1521 are rotated around the handlebar 1510 by hand. As shown in FIG. 15B, an extension 1521a is formed on the housing 1521 to enable a finger of the hand to apply additional rotational force. A locking flange of the tube locks into a recessed cutout in a side plate of the housing 1521 (instead of the core of a rack wheel as in the RHA of FIG. 15A), so that rotation of the grip and tube produces corresponding rotation of the housing 1521. A large-diameter rack hub (as discussed above, a quarter-gear composed of a toothed arc on a cylindrical hub that is longer than the hub of the rack wheel) is positioned within the housing and locked to the handlebar (e.g., with a collet lock or a hub lock) so that the rack wheel remains stationary within the housing 1521. A small diameter pinion gear that mates with the rack hub is positioned in, and attached to, the housing 1521, so that when the housing 1521 rotates, the pinion gear is rotated about the rack hub, thereby causing rotation of the pinion gear. A threaded lead screw extends from a side of the pinion gear into a “barrel” of the housing 1521. Within the barrel, the screw threads into a female coupler. A guide pin channel is formed on an exterior wall of the coupler into which a guide pin is inserted to prevent the coupler from spinning in the barrel, as discussed in more detail above, and a hole is formed in the end of the coupler opposite that into which the screw is threaded to receive the clutch cable tip. Rotation of the pinion (and, thus, the screw) by the rack hub pulls the coupler down the barrel with the clutch cable in tow. The outside of the housing around the barrel is threaded and grooved to mate with a large-diameter cable tension adjuster 1514 (see FIG. 23). The entire housing can be covered with a removable mudguard (not shown in FIG. 15B).

FIGS. 21A and 21B are cross-sectional views of part of a rotatable housing RHA for cable actuation according to the invention, illustrating rotation of a housing around a locked rack wheel during operation of the RHA. A rack hub 2101 is positioned adjacent a stop block 2102 within a housing 2100 such that the rack of the rack hub 2101 meshes with a pinion gear 2103. In FIG. 21A, the housing 2100 is positioned before rotation of a handgrip (and housing 2100). In FIG. 21B, the housing 2100 has been rotated in a counterclockwise direction as a result of rotation of the handgrip. As can be seen, the rack hub 2101 is fixed and does not rotate. The stop block 2102 rotates with the housing 2100, as does the pinion gear 2103. As the pinion gear 2103 moves about the rack hub 2101 as a result of rotation of the housing 2100, the pinion gear 2103 rotates on its axis, in turn rotating a screw (not shown in FIGS. 21A and 21B) that is attached to the pinion gear 2103.

A rotatable housing that rotates with the grip can advantageously enable greater torque to be applied when rotating the handgrip, which can be useful in ensuring that adequate actuation force is applied (e.g., adequate force is applied to displace a clutch). However, some vehicle operators (e.g., motorcycle riders) may prefer that the grip remain stationary, rather than be allowed to rotate. The RHA according to this embodiment of the invention can be implemented so that the grip is attached directly to the handlebar with no tube underneath and so that the grip is not attached to the rotatable housing. Consequently, the housing can be rotated to produce clutch actuation as described above without rotation of the grip. Such an assembly can be referred to as a Rotating Assembly (as compared to a Rotating Handgrip Assembly).

b. Modified Components

The following describes aspects of the components of the RHA illustrated in FIG. 15B which differ from the corresponding components of the RHA illustrated in FIG. 15A.

i. Rack Hub

In a rotatable housing RHA for cable actuation, the rack hub is constructed with a larger diameter/longer hub which runs the full width of the housing. The hub is fitted externally with two sealed bearings which are recessed into each side of the housing, or one wider needle bearing. In one version of the rack hub, the hub is threaded internally with a tapered tap. A collet lock, a collet-like locking insert with tapered external threads, screws into the rack wheel's elongated hub and locks the collet lock and hub onto the handlebar as they are tightened. The collet lock's threads may be left or right-handed to suit the forces present on the left or right side of the handlebar. The collet head or collar is fitted with axial set screws to prevent loosening. The housing is secured in between the two pieces of the rack hub/collet lock, and rotates on the two sealed bearings or wider needle bearings of the rack wheel's elongated hub. Another version of the rack hub incorporates a hub lock design. Inside the hub lock, multiple radial set screws press inwardly on knurled plate sections to lock the rack hub onto the handlebar. This “flush” design features a narrower profile than the collet lock, and affords an option for the housing known as a pivot clamp. Tooth sizing and rack-to-pinion gear ratios can be as described above for stationary housing RHA for cable actuation.

As detailed above, the rack hub may be part of a prime pinion/rack hub gear pair, and may also be machined on its inner face with a pattern of grooves for haptic feedback.

ii. Rotating Control Housing and Options

The rotatable housing includes several changes from the stationary housing. First, the side plate is thickened, e.g., by about 3 mm-4 mm, to house the locking flange of the grip tube. A self-lubricating plastic gasket separates the side plate and locking flange from the rack wheel and prevents any friction between them. The gasket also seals the rack wheel/pinion recesses from the elements. The side plate may also include a metal extension (or “finger paddle”) which acts as a leverage point for the index and middle fingers. This leverage point greatly increases finger torque on the housing and with re-gearing may decrease the amount of rotation required to actuate clutch mechanisms with heavier cable pulls (higher spring forces). In rearward-actuating housings, an optional exterior thumb paddle may be added to the bottom of the housing to provide extra leverage for the rearward action.

The housing is widened to accommodate the rack hub's increased width. The bore in the housing for the rack wheel is enlarged to accommodate the increase in rack wheel hub diameter and length. An additional recess is made on the opposite side of the housing's bearing recess from the stationary housing described above. This second recess accommodates the second sealed bearing required for a rotatable housing. Alternatively, the housing may utilize one or more cylindrical needle bearings for articulation.

While the advantages of having the grip rotate with the rotatable housing are significant in adding torque, some riders may prefer a stationary grip with no tube. In this case, rotatable housing RHAs (i.e., the RHAs shown in FIGS. 15A and 15B) can be made without accommodating a rotating tube and grip at the side plate. The housing and grip are separate, with the grip being attached directly to the handlebar with no tube underneath. When the housing is rotated, the grip does not move. This reclassifies the housing as simply RA (Rotating Assembly).

iii. Mudguard

The mudguard is largely the same as that described above for the stationary housing RHA for cable actuation. Some of the measurements of the mudguard are modified so that the mudguard will fit the modified housing required for rotation. Also to accommodate the rotatable housing, the mudguard includes a larger cutout around the head of the collet lock. This ensures rotation without friction or interference from the interaction of the mudguard with the collet lock's head. The mudguard can also be modified as required to accommodate the accessories discussed above.

B. RHAs for Hydraulic Actuation

1. Stationary Housing

a. Overview of Construction and Operation

FIG. 15C is a perspective view of a handlebar 1510 on which is mounted an RHA, according to an embodiment of the invention, that can be used with hydraulically-actuated apparatus (e.g., a hydraulically-actuated clutch, in which case the RHA is a C-RHA) and that is housed in a stationary housing 1511 (for convenience, sometimes referred to herein as a “stationary housing RHA for hydraulic actuation”). As explained briefly below and in more detail elsewhere herein, the RHA converts the rotational motion of a hand twisting a handgrip 1512 into the linear push of hydraulic fluid down a clutch line 1523. As will be appreciated from the following description, many aspects of the construction and assembly of a stationary housing RHA for hydraulic actuation are the same as, or similar to, those of a stationary housing RHA for cable actuation. A grip and tube are rotated around the handlebar 1510 by hand. A locking flange of the tube locks into the core of a large diameter rack wheel (as discussed above, a quarter-gear composed of a toothed arc on a cylindrical hub) so that rotation of the grip and tube rotate the rack wheel. Rotation of the rack wheel rotates a corresponding small-diameter pinion gear that mates with the rack wheel. A threaded lead screw extends from a side of the pinion gear into a “barrel” of the housing 1511. Within the barrel, the screw threads into a piston (a.k.a. plunger). A guide pin channel is formed on an exterior wall of the piston between primary and secondary seals of the piston, and into which a guide pin is inserted to prevent the piston from spinning in the barrel, as discussed in more detail above. Rotation of the pinion gear (and, thus, the screw) by the rack wheel pushes the piston down the barrel with hydraulic fluid locked in front of the primary seal. The secondary seal prevents leakage and helps circulate fluid through a fluid reservoir 1524. The housing above the barrel can be machined to form a standard hydraulic fluid reservoir (an integrated fluid reservoir) which feeds fluid to the piston and hydraulic clutch line. Alternatively, the fluid reservoir may be located remotely and connected via a hose to a reservoir feed port on the barrel. (FIGS. 15C, 15D, 24, 27 and 33 illustrate an integrated reservoir). The entire housing can be covered with a removable mudguard (not shown in FIG. 15C).

FIG. 24 is a cross-sectional view of part of an RHA for hydraulic actuation, according to an embodiment of the invention, illustrating construction and assembly of parts of a RHA for hydraulic actuation that are enclosed within a housing 2400. A screw 2402 extends from a hub of a pinion hub. A snap ring 2404 is positioned adjacent the pinion hub. The screw 2402 extends into a barrel 2400a of the housing 2400 where the screw 2402 is threaded into a piston 2401 positioned within the housing barrel 2400a. Hydraulic seals 2403a and 2403b are positioned in corresponding grooves formed in the piston 2401. Fluid inlet port 2407 and compensating port 2408 are formed in the housing barrel 2400a to allow exchange of fluid with the fluid reservoir 2405. The piston 2401 pushes hydraulic fluid out of the barrel 2400a through a hydraulic line 2406, which is attached to the housing 2400 by a hydraulic fitting 2404, to enable actuation of the apparatus being controlled with the RHA.

b. Modified Components

The following describes aspects of the components of the RHA illustrated in FIG. 15C which differ from the corresponding components of the RHA illustrated in FIG. 15B.

i. Pinion

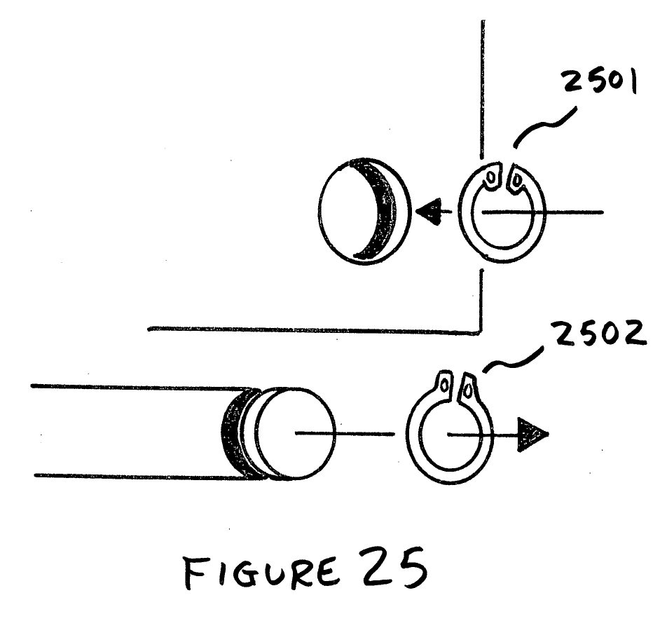

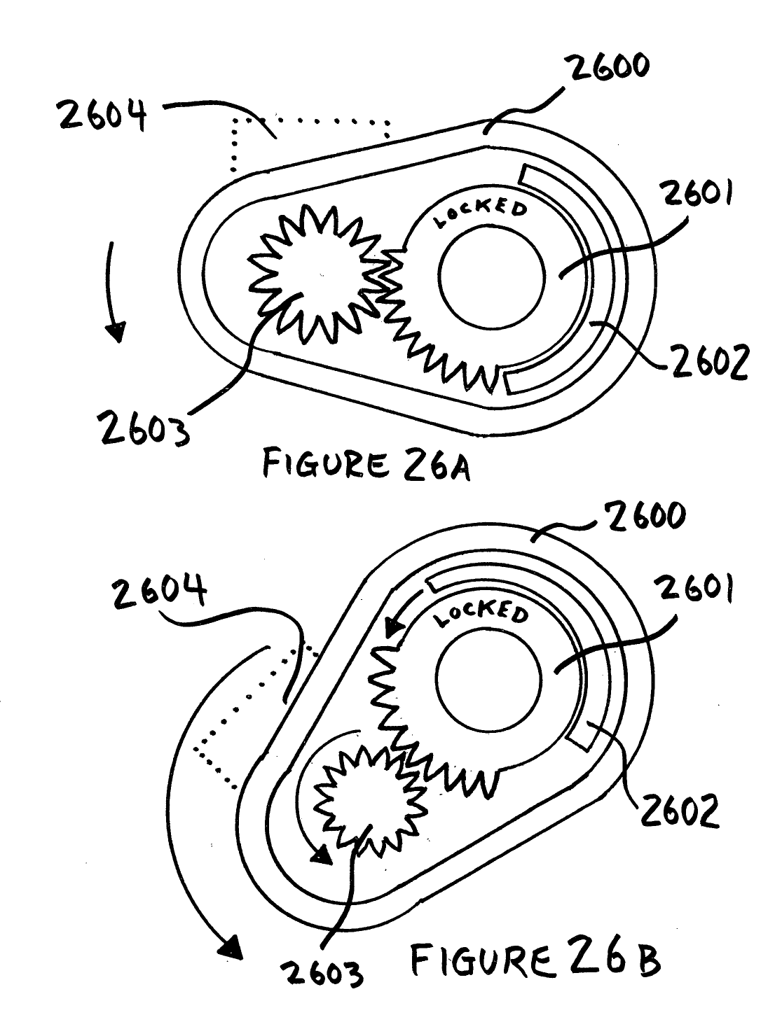

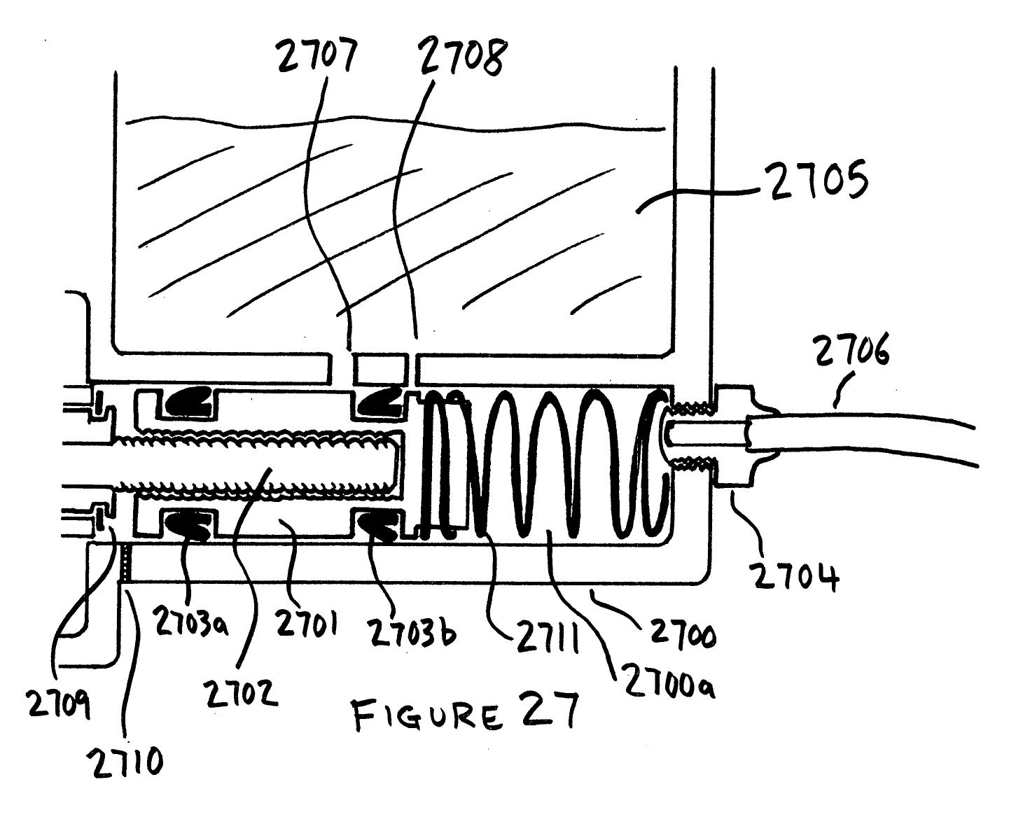

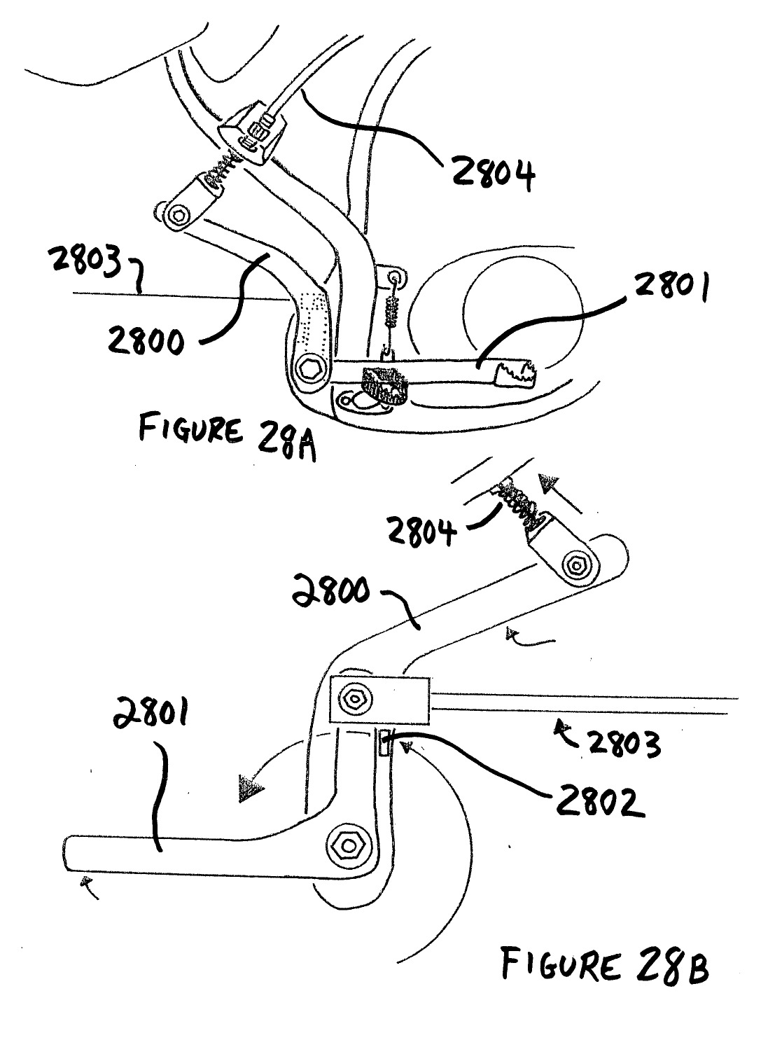

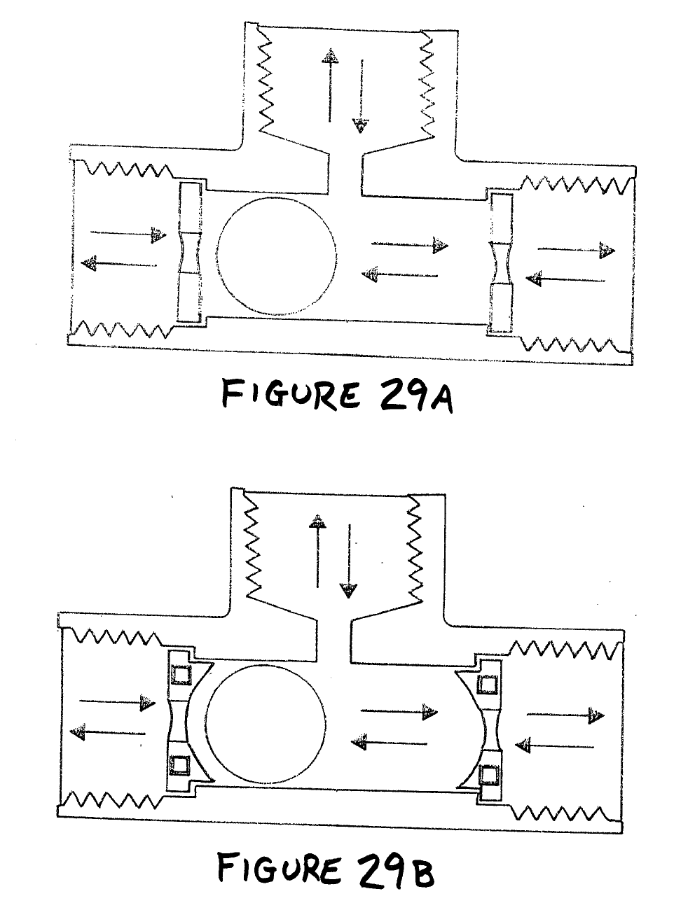

Because of the expansion forces created by pushing a hydraulic piston, the screw, pinion, pinion bearing, and housing need some way of preventing parts from being pushed out of place. For RHAs for hydraulic actuation, snap rings (FIG. 25), also known as circlips, can solve the dislocation problem. An external snap ring can be used on the innermost rim of the pinion hub to prevent the hub from being pushed through the sealed bearing. An internal snap ring can be used at the outermost rim of the pinion housing's sealed bearing recess to prevent the bearing from being pushed out of the housing. FIG. 25 is a perspective view of an internal snap ring 2501 and an external snap ring 2502 and corresponding grooves that can be used with embodiments of the invention. All other features of the pinion for the stationary housing RHA for hydraulic actuation are as described above for the pinion of the stationary housing RHA for cable actuation. Note that the pinion and hub may be threaded for swapping prime gear sets.

ii. Screw

The screw for the stationary housing RHA for hydraulic actuation may include threads with reversed “handedness” compared to the screw from the stationary housing RHA for cable actuation; this change-converts the cable pull into a fluid push. For extra security, the screw may be fitted with an external snap ring beside the innermost face of the pinion hub. Other than these details, the screw for the stationary housing RHA for hydraulic actuation is as described above for the screw of the stationary housing RHA for cable actuation.

iii. Piston

The piston is the hydraulic equivalent of the coupler. Like the coupler, the bore of the piston can be machined internally with threads which match the screw. However, that's where the similarities end: the coupler is designed to pull a cable whereas the piston is designed to push hydraulic fluid. The piston includes two grooves which can be machined into the exterior of the piston to accommodate directional hydraulic seals. These seals can be expanding-skirt type synthetic-rubber seals typical of brake master cylinders from Nissin, Magura, and others. The seal materials used need to be compatible with the type of fluid in use (hydraulic mineral oil-compatible for clutch applications and brake fluid-compatible for brake applications). Some clutch master cylinder designs substitute a conventional o-ring for the secondary seal, presumably for cost and simplicity reasons; the RHA piston can be machined for either seal configuration. The o-ring materials used need to be compatible with the type of fluid in use (hydraulic mineral oil-compatible for clutch applications).

Between these seals, the piston includes the same guide pin channel as described above for the stationary housing RHA for cable actuation. The guide pin prevents the piston from twisting as the screw turns into the piston core. The guide pin channel also limits the range of piston travel so that the primary and secondary seals move in precise relation to the fluid inlet port and compensating port, and prevents the secondary seal from being pushed past the fluid inlet port. The rest of the piston surface between the seals (and away from the guide pin channel) may be machined with helical or serpentine fluid circulation channels; these channels help move fluid through the barrel and reservoir. Finally, the tip of the piston protrudes just beyond the face of the primary seal and stops the piston as the piston reaches the end of the barrel. The tip does not require a return spring as is typical of lever-operated brake and clutch master cylinders. The spring is not mandatory since the screw makes positioning pushing or pulling) the piston easy. The lack of a return spring makes the overall barrel length shorter and also reduces the total force required to actuate the mechanism.

iv. Stationary Control Housing and Options

As detailed for the pinion of the stationary housing RHA for hydraulic actuation, an internal snap ring can be used at the outermost rim of the pinion housing's sealed bearing recess to prevent the bearing from being pushed out of the housing. Additional changes are required to support the hydraulics: the top of the barrel section of the housing can be machined with a conventional hydraulic fluid reservoir. The reservoir includes a conventional two-screw cap and synthetic rubber gasket insert. The cap may be machined with a bracket to accommodate small levers like those used for compression releases. An exposed face of the reservoir may include a fluid level window. The reservoir drains into the housing barrel through two holes: a large fluid inlet port and a small compensating port. The holes are aligned on the axis of the barrel and are separated by a distance just greater than the length of the piston's primary seal. The pinion end (dry end) of the barrel may include a drain hole or holes near the lowest point of the barrel; these holes may be fitted with filters to prevent dust from entering the barrel. The barrel's other end is drilled above center and tapped with threads to match conventional or quick-release (Staubli) hydraulic line fittings. The exterior of the barrel end is not equipped with a clutch cable adjuster since the hydraulic mechanism is self-adjusting. The gear section of the housing may include a spring-loaded detent inside the rack wheel for haptic feedback. The clamping options, mounts, switches, locks, and side plate can be the same as those described above for the stationary housing RHA for cable actuation.

v. Mudguard

The mudguard can be slipped on to the housing from the top and covers the reservoir cap and most of the housing. The area over the reservoir cap may include a hole for a compression release lever. The mudguard can be split in two places: along the bottom of the reservoir/barrel section and also at the back of the handlebar section. The barrel split allows the mudguard to wrap over the reservoir and fasten underneath the barrel with a built-in rubber fastener (or other appropriate fastener). The handlebar split allows the mudguard to wrap over and under the housing at the handlebar joint and fasten at the back of the housing with a built-in rubber fastener (or other appropriate fastener). Materials used for the mudguard can be automotive-grade chemical-resistant and UV light-resistant thermoplastic elastomers and synthetic rubber compounds. The mudguard can also be modified as required to accommodate the accessories described above.

2. Rotatable Housing

a. Overview of Construction and Operation

FIG. 15D is a perspective view of a handlebar 1510 on which is mounted an RHA, according to an embodiment of the invention, that can be used with hydraulically-actuated apparatus (e.g., a hydraulically-actuated clutch, in which case the RHA is a C-RHA) and that is housed in a rotatable housing 1521 (for convenience, sometimes referred to herein as a “rotatable housing RHA for hydraulic actuation”). As explained briefly below and in more detail elsewhere herein, the RHA converts the rotational motion of a hand twisting a handgrip 1512 into the linear push of hydraulic fluid down a clutch line 1523. As will be appreciated from the following description, many aspects of the construction and assembly of a rotable housing RHA for hydraulic actuation are the same as, or similar to, those of a rotatable housing RHA for cable actuation and/or a stationary housing RHA for hydraulic actuation. A grip, tube and the rotatable housing 1521 are rotated around the handlebar 1510 by hand (see FIGS. 26A and 26B). As shown in FIG. 15D, an extension 1521a is formed on the housing 1521 to enable a finger of the hand to apply additional rotational force. A locking flange of the tube locks into a recessed cutout in a side plate of the housing 1521 (instead of the core of a rack wheel as in the RHAs of FIGS. 15A and 15C), so that rotation of the grip and tube produces corresponding rotation of the housing 1521. A large-diameter rack hub (as discussed above, a quarter-gear composed of a toothed arc on a cylindrical hub that is longer than the hub of the rack wheel) is positioned within the housing and locked to the handlebar (e.g., with a collet lock or a hub lock) so that the rack wheel remains stationary within the housing 1521. A small diameter pinion gear that mates with the rack hub is positioned in, and attached to, the housing 1521, so that when the housing 1521 rotates, the pinion gear is rotated about the rack hub, thereby causing rotation of the pinion gear (see FIGS. 26A and 26B). A threaded lead screw extends from a side of the pinion gear into a “barrel” of the housing 1521. Within the barrel, the screw threads into a piston (a.k.a. plunger). A guide pin channel is formed on an exterior wall of the piston between primary and secondary seals of the piston, and into which a guide pin is inserted to prevent the piston from spinning in the barrel, as discussed in more detail above. Rotation of the pinion gear (and, thus, the screw) by the rack wheel pushes the piston down the barrel with hydraulic fluid locked in front of the primary seal. The secondary seal prevents leakage and helps circulate fluid through a fluid reservoir 1524. The housing above the barrel can be machined to form a standard hydraulic fluid reservoir (an integrated fluid reservoir) which feeds fluid to the piston and hydraulic clutch line. Alternatively, the fluid reservoir may be located remotely and connected via a hose to a reservoir feed port on the barrel. (FIGS. 15D, 24, 27 and 33 illustrate an integrated reservoir). The entire housing can be covered with a removable mudguard (not shown in FIG. 15D).

FIGS. 26A and 26B are cross-sectional views of part of a rotatable housing RHA for hydraulic actuation according to the invention, illustrating rotation of a housing around a locked rack hub during operation of the RHA. A rack hub 2601 is positioned adjacent a stop block 2602 within a housing 2600 such that the rack of the rack hub 2601 meshes with a pinion gear 2603. A hydraulic fluid reservoir 2604 is formed as part of the housing 2600. In FIG. 26A, the housing 2600 is positioned before rotation of a handgrip (and housing 2600). In FIG. 26B, the housing 2600 has been rotated in a counterclockwise direction as a result of rotation of the handgrip. As can be seen, the rack hub 2601 is fixed and does not rotate. The stop block 2602 rotates with the housing 2600, as does the pinion gear 2603 (and hydraulic fluid reservoir 2604). As the pinion gear 2603 moves about the rack hub 2601 as a result of rotation of the housing 2600, the pinion gear 2603 rotates on its axis, in turn rotating a screw (not shown in FIGS. 26A and 26B) that is attached to the pinion gear 2603.

A rotatable housing that rotates with the grip can advantageously enable greater torque to be applied when rotating the handgrip, which can be useful in ensuring that adequate actuation force is applied (e.g., adequate force is applied to displace a clutch). However, some vehicle operators (e.g., motorcycle riders) may prefer that the grip remain stationary, rather than be allowed to rotate. The RHA according to this embodiment of the invention can be implemented so that the grip is attached directly to the handlebar with no tube underneath and so that the grip is not attached to the rotatable housing. Consequently, the housing can be rotated to produce clutch actuation as described above without rotation of the grip. Such an assembly can be referred to as a Rotating Assembly (as compared to a Rotating Handgrip Assembly).

b. Modified Components

Some components of the rotatable housing RHA for hydraulic actuation can be produced by combining the aspects of the corresponding components of the rotatable housing RHA for cable actuation and the stationary housing RHA for hydraulic actuation, as described above. The housing can be produced by combining the rotatable housing of the rotatable housing RHA for cable actuation with the hydraulic section of stationary housing RHA for hydraulic actuation. The mudguard can also be produced in view of the combination of the rotatable housing of the rotatable housing RHA for cable actuation with the hydraulic section of stationary housing RHA for hydraulic actuation.

C. B-RHA (Rotating Handgrip Assembly For Brake Actuation)

With the advent of the C-RHA, motorcycle controls design may have evolved to designate levers as stopping controls and rotating handgrips as acceleration controls (as described above). The use of the C-RHA for clutch control allows a rider to mount a conventional lever-actuated cable perch (typical for rod-actuated drum brakes) or a conventional lever-actuated master cylinder perch (typical for hydraulic disc brakes) on the left handlebar (or pivot clamp) for rear brake actuation. These lever mounts may work with (dual actuation) or replace (solo actuation) the stock rear brake pedal. However, there may be situations which benefit from using rotating handgrip assemblies for stopping.

For example, a motorcycle with an automatic clutch mechanism (such as those offered by Rev-Loc and Rekluse) gives a rider the option of using the left hand lever for manual override of the automatic clutch mechanism or for some other use such as braking. In this situation, the C-RHA may provide additional benefits. Like the lever, the C-RHA may also be used for manual override of the automatic clutch mechanism, but the C-RHA provides the additional benefit of keeping the rider's grip on the handlebars intact.

Riders who choose not to install a manual override to the automatic clutch may want to use a rotating handgrip assembly for braking. With slight modifications, the RHAs illustrated and described above with respect to FIGS. 15A through 15D can be applied to brake actuation. Usually, this means rear brake actuation. Most modern motorcycles use hydraulic caliper/disc systems for rear braking, but there are still rod and cable-actuated rear drum brakes in production. The RHAs for cable actuation are typically applicable to these drum brakes, while the RHAs for hydraulic actuation are typically applicable to hydraulic systems. (Note: there are exceptions, such as Magura's Jack hydraulic lever/master cylinder/slave cylinder replacement for lever and cable-actuated controls). Longer S-curved cables can stretch and create a spongy feel in the controls. The hose and slave cylinder of the Jack can be mated with the hydraulic B-RHA to improve the feel and response of drum brake systems.

The shorter stroke required to actuate most hydraulic brakes means that hand and wrist power can be multiplied by “gearing down” the rack wheel/rack hub, pinion, and screw thread pitch. The rack wheel/rack hub's pitch circle diameter may decrease, while the pinion pitch circle diameter may increase to “amplify” muscle input. The screw's thread pitch may also flatten or decrease (while remaining in the overhauling/backdriving class) for additional mechanical advantage.

Piston seals for braking applications need to be expanding-skirt type for safety and reliability (it is typically best not to use o-ring secondary seals for braking). The seal materials used need to be compatible with the type of fluid in use (DOT-X brake fluid-compatible for brake applications). Brakes lack the built-in springs of the clutch plates; the barrel of the B-RHA may be equipped with a return spring to simplify assembly and to ensure a rebound effect when the handgrip is released. Alternatively, the primary seal may be attached to the piston end of the return spring so that the piston's face can be drilled with tiny flow holes (FIG. 37). These flow holes help the piston rebound more quickly when the brake is released.

FIG. 27 is a cross-sectional view of part of a B-RHA for hydraulic actuation, according to an embodiment of the invention, illustrating construction and assembly of parts of a RHA for hydraulic actuation that are enclosed within the housing 2400. In general, the parts of the B-RHA are the same as those discussed above with respect to FIG. 24. One difference is the presence of the return spring 2711 in the hydraulic fluid in the housing barrel 2400a.

The stroke of most rod and cable-actuated rear drum brakes is slightly longer than that of rear hydraulic discs. The B-RHA for cable actuation is designed to match that stroke while still providing maximum force multiplication. As detailed above, the B-RHA for cable actuation may be used in concert with the foot-actuated rear brake pedal. Consequently, the lower end of the B-RHA cable may connect to a secondary arm (FIGS. 28A and 28B) which forces that rear brake pedal forward to actuate the rear brake. The secondary arm assembly is an auxiliary device that may make use of the stock clutch cable in many applications.

In many cases, the B-RHA works as a secondary actuator for dual control. This means that the stock foot-actuated rear brake pedal works normally until rough terrain may require the rider to extend his or her right leg for extra stability. With the right leg extended, the rider cannot operate the rear brake pedal with the right foot. The B-RHA works as a secondary actuator by affording the rider another way to apply the rear brake.

For rear drum systems, the B-RHA's coupler pulls a cable (often the leftover clutch cable) that is connected to an auxiliary device: the secondary arm. The secondary arm forces the rear brake pedal forward (and downward) to actuate the rear brake. When the rider's foot returns to the brake pedal and depresses the brake pedal, the secondary arm remains still; this prevents the secondary arm cable from feeding slack back to the B-RHA mechanism. Alternatively, an hydraulic B-RHA can be connected to the hose and slave cylinder of Magura's Jack system to elliminate the spongey feel created by long S-curved cables.

For hydraulic systems, the B-RHA output is connected with an hydraulic brake line. The system can be “plumbed” in one of several ways. First, the rider may choose to bypass or remove the rear brake pedal/rear master cylinder entirely and connect the B-RHA directly to the brake caliper with a new extra-long brake line. Secondly, the rider may choose dual actuation. In this case, the brake line is routed into a junction valve, such as those offered by Rekluse & GP Tech L.L.C., which replaces the rear master cylinder's fluid reservoir fitting (and eliminates the reservoir). Then the B-RHA reservoir feeds both the B-RHA piston and the rear master cylinder's piston through the junction valve. Unfortunately, a different junction valve must be must be offered for each model of rear master cylinder since the fluid reservoir fittings vary significantly between manufacturers, and the tiny fluid inlet holes cause extra resistance when squeezing the secondary brake lever.

There are other possibilities for dual actuation. The switch valve and the magnetic switch valve (FIGS. 29A and 29B) are variations on a common theme: utilize the rear brake pedal master cylinder assembly “as-is” by connecting the B-RHA to the assembly using common, off-the-shelf fittings such as 10 mm two-hole “banjo” bolts with copper or aluminum washers. Both of these mechanisms route hydraulic forces from either the brake pedal's master cylinder piston or the B-RHA's piston to the rear brake caliper. Whichever piston is inactive gets rotatable housinged off by the valve to prevent misdirected fluid forces (which would otherwise slowly flood the opposing actuator's fluid reservoir).

The switch valve and the magnetic switch valve include three ports. The ports are threaded to match standard hydraulic fittings and adaptors such as the 10 mm “banjo” type fittings offered by Goodridge Inc. and others. Ports 1 and 2 are co-linear and share the same bore, while port 3 is typically orthogonal to the common axis of ports 1 and 2. Typically, port 3 will connect to the rear brake caliper using the existing brake line and stock banjo bolt. Port 1 will connect to the B-RHA and port 2 will connect to the rear master cylinder; in both cases, the most convenient/most available fittings and adaptors may be used.

All three of the ports are 2-way: fluid may travel in either direction through the ports. However, the valve is designed to switch the flow of fluid forces between the B-RHA and the rear master cylinder to the rear brake caliper. Consequently, ports 1 and 3 may be active while port 2 is sealed off, then the switch occurs and ports 2 and 3 may be active while port 1 is sealed off.

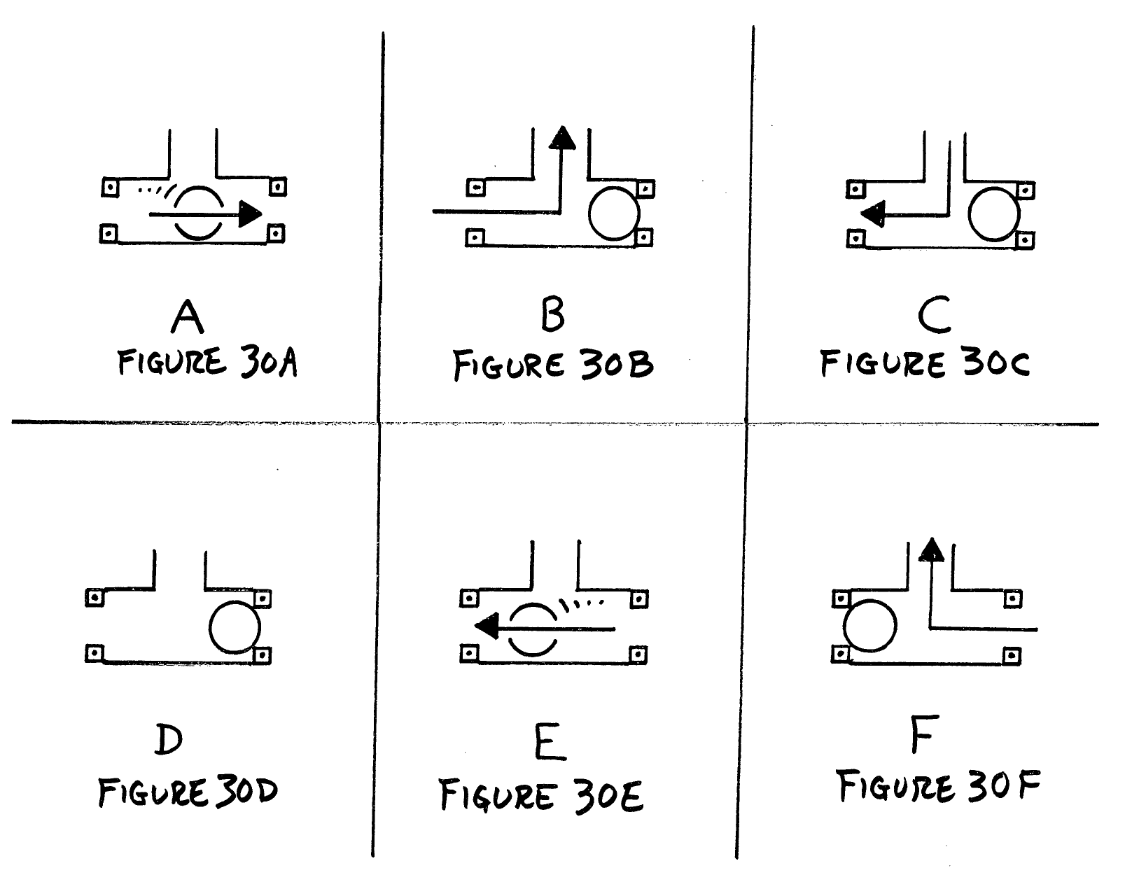

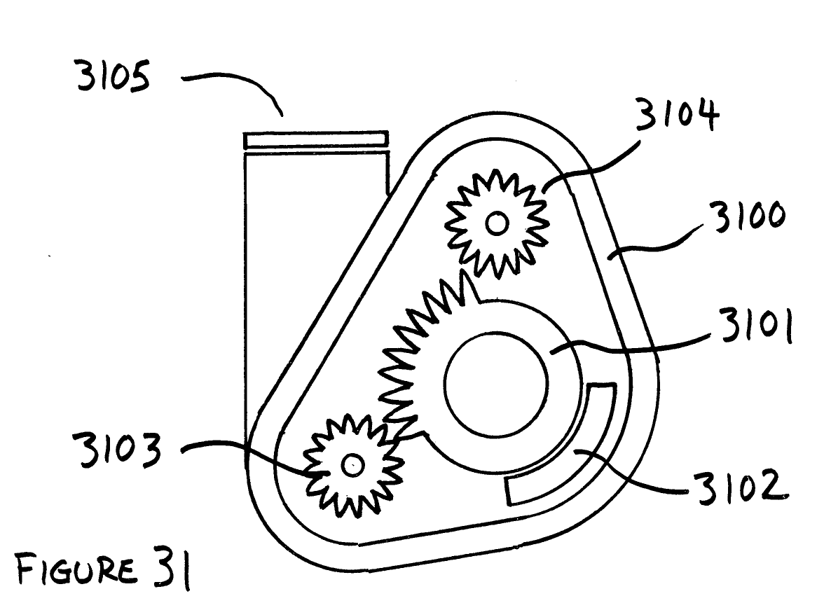

The switch occurs when the rider alternates between hand actuation (B-RHA) and foot actuation (rear brake pedal). Fluid forces from the most recently actuated control force the switch to occur inside the switch valve (FIGS. 30A through 30F). In the regular switch valve, a precision (grade 3) ball bearing or precision rod segment (both rust-proof; usually metal) is forced from one side of the valve to the other as the alternate control is actuated. The connection between that control and the rear brake caliper is held open by hydraulic fluid forces. In the magnetic switch valve, matched washer-shaped ring magnets encased in fluid-proof plastic are press-fit into each end of the main bore. These magnetic forces help lock the ball or rod segment (both rust-proof, usually chrome-plated steel) in place after each switch occurs and may improve switching performance in extremely rough conditions.

The final option for dual actuation should be familiar. The secondary arm from the rod-actuated rear drum system may also be used on hydraulic brakes since the secondary arm/pedal connection is strictly mechanical. The rear brake pedal which actuates the rear master cylinder can be fitted with the secondary arm in the same way used for the rear brake pedal to the rear drum. The connection to the B-RHA and the type of B-RHA used can be the same as described in the rear drum section above.

This section focused on the B-RHA and the accessories required to use it as a secondary actuator for the rear brake. Note that all of these accessories (such as the secondary arm, junction valve, switch valve, etc.) for secondary actuation of the rear brake with a B-RHA can alternatively be used with a conventional lever-actuated cable or lever-actuated hydraulic assembly. A table showing several possible combinations of these controls is shown in FIG. 40.

D. X-RHA (The Rotating Handgrip Assembly as a Compound Actuator)

There is an additional class of RHA which can best be described as a compound actuator. Actuation of multiple systems can be combined into one RHA, e.g., a BC-RHA (a combination of brake and clutch control) or a TB-RHA (a combination of throttle and brake control). This may be deemed desirable by some riders.

The simplest way to describe “compounding” is dual-actuation within a single X-RHA. For example, a single left-hand grip/tube/rack wheel or rack hub assembly may act on two different pinion/screw mechanisms at different points in the rotary arc of the assembly (FIG. 31). Recall that the rack wheel/rack hub is a sector gear which with precision design can consistently engage and disengage from non-free-spinnning bounded-rotation pinions. The grip rests at a neutral center point in the arc. Rotating forward, the rack precisely engages the lower pinion for brake actuation. Afterward, the grip returns to the neutral point. Rotating backward, the rack precisely engages the upper pinion for clutch actuation. One RHA actuates two systems independently by rotating forward or backward: dual-actuation within a single X-RHA.

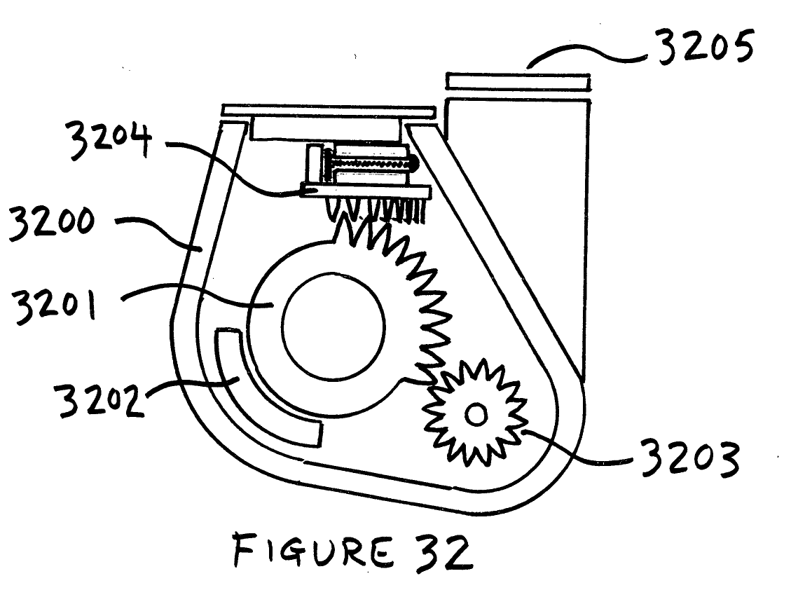

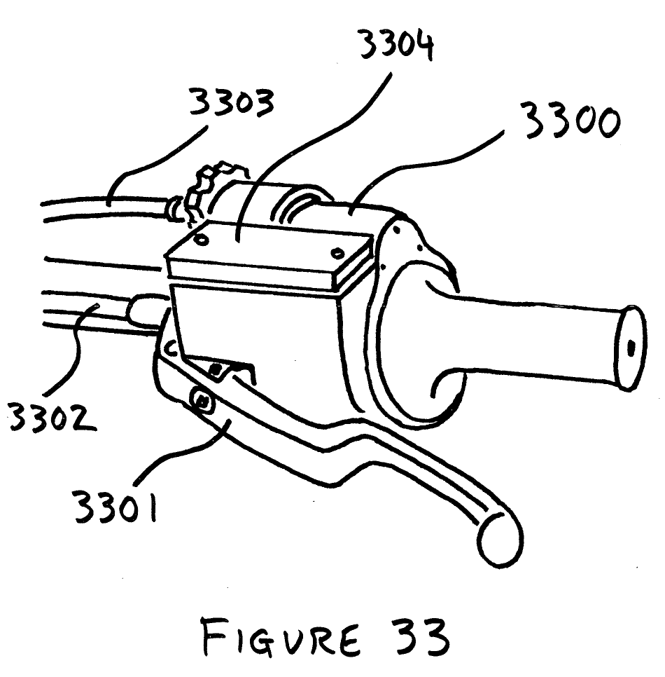

Or, for example, a single right-hand grip/tube/rack wheel assembly (FIG. 32) may act on two different gear mechanisms at different points in the rotary arc of the assembly. The grip rests at a neutral or center point in the arc. Rotating forward, the rack engages the lower pinion for brake actuation. Afterward, the grip returns to the neutral point. Rotating backward, the rack engages the upper face gear/cable sheave for throttle actuation. One RHA actuates two systems independently by rotating forward or backward: once again, dual-actuation within a single X-RHA.

Any of the above compound actuators can utilize a stationary housing with a rotating grip, or a rotatable housing and grip with a stationary rack hub and collect lock or hub lock. Below, an implementation is described that utilizes a rotatable housing and grip with a stationary rack hub and collect lock or hub lock.

Any of the above compound actuators can utilize a stationary housing with a rotating grip, or a rotatable housing and grip with a stationary rack wheel/rack hub with a collet lock or hub lock. Below, an implementation is described that utilizes a rotatable housing and grip with a stationary rack hub with a collet lock or hub lock.

E. X-RHA Hybrids

In this implementation, a lever-operated rear brake master cylinder and reservoir is combined with a C-RHA in a rotatable housing (FIG. 33). Note that in this example, the master cylinder is a radial design as opposed to the more conventional axial design. The radial design may integrate more easily with the X-RHA housing. The lever mount, rear brake master cylinder, and reservoir are built into the X-RHA's rotatable housing. Here, the lever rotates with the X-RHA housing to provide extra torque for the rider's hand when rotating the housing. This is acheived when the rider extends one or more fingers onto the lever's top edge and presses down on the lever as he rotates the grip and housing. The lever becomes a dual-axis tool. In the first axis, the lever creates a horizontal arc as it is pulled in toward the grip. In the second axis, the lever creates a vertical arc as it is pressed down and around the handlebar. In both cases, the lever provides additional leverage. In addition, the plane defined by the lever's travel maintains a fixed radial position relative to the rider's hand, grip, and tube since they rotate together. This feature guarantees that the rider will always have an optimal straight pull on the lever relative to his hand rotating the grip when the clutch is being engaged and disengaged. This straight pull maximizes finger strength due to the optimal positions of the wrist and thumb on the grip. This feature is possible because of the rotating grip/housing of the X-RHA. If the grip did not rotate with the lever, the rider would experience a decrease in lever finger strength due to the bend in his wrist as the lever and grip rotated away from each other. In addition, the force of his finger contraction on the lever would convert from an optimal radial force vector to a compromised tangential force vector.

In the foregoing implementation, the force required to rotate the X-RHA is decreased by the radial leverage provided by the integrated lever, and the optimal straight pull of the lever is maintained for the hand during that rotation. While manufacturers such as Magura have combined controls such as throttle and brake lever mounts into a single housing for many years, the function and usability of either of those controls has not been improved by the combination. Furthermore, the choice of lever-actuated brake and RHA-actuated clutch provides the most consistency of vertical leverage for clutch actuation since the brake lever's range of motion in the horizontal plane is much smaller than the clutch lever's range of motion in the horizontal plane. This is like having a consistently longer radial lever.

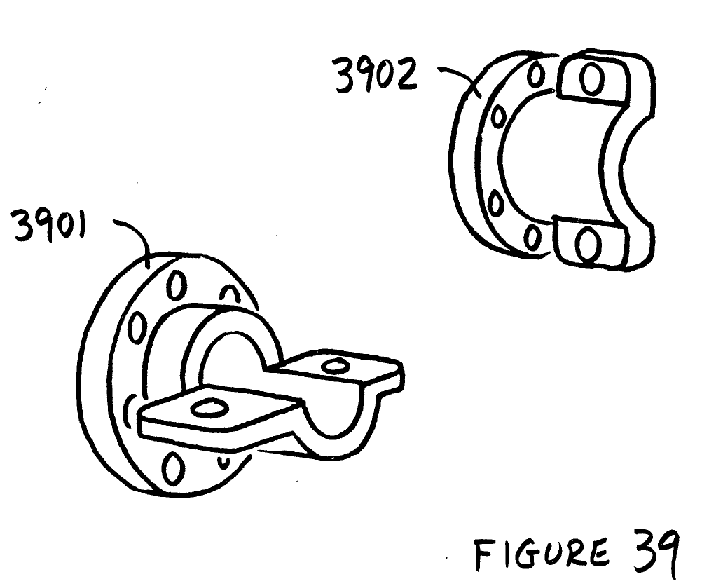

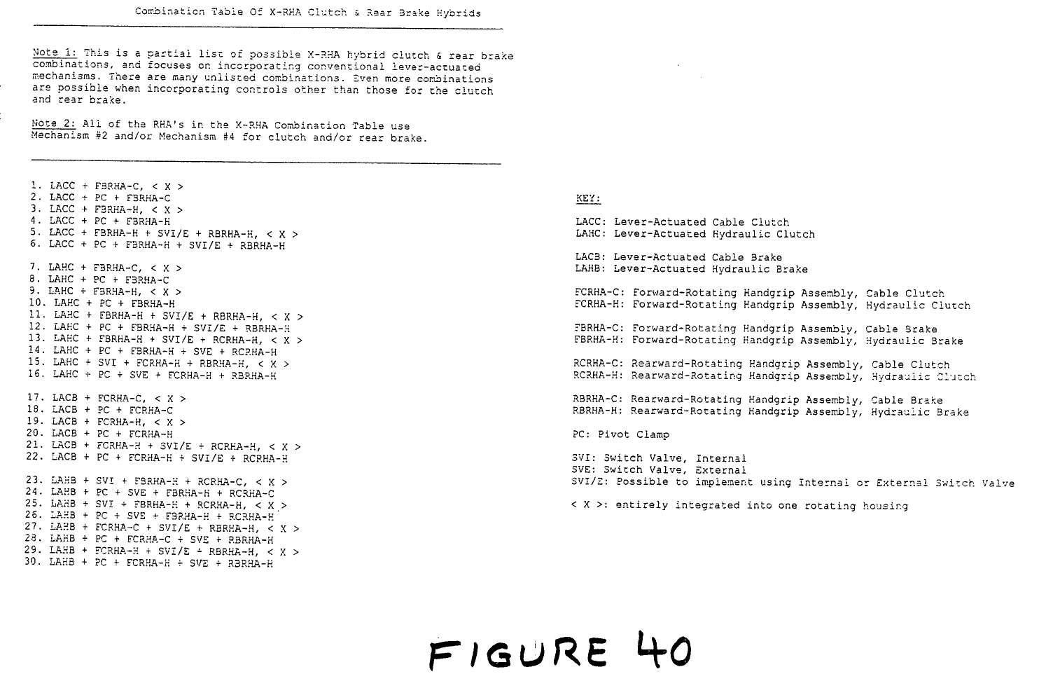

Another implementation of compound actuation with a rotatable housing X-RHA features a pivot clamp addition. (FIG. 38)) The pivot clamp accommodates conventional lever-actuated perches by replacing the clamp portion of the perch. Instead of pinching the handlebar with the stock clamp, the perch is mounted to the pivot clamp with the 2 stock bolts. Rather than pinching the handlebar, however, the pivot clamp is designed to provide just enough clearance with its spacer washers to allow the perch to pivot around the handlebar while still remaining securely fastened to the handlebar. The pivoting action can be facilitated with a thin self-lubricating plastic bushing which fits around the handlebar. Note that each pivot clamp is designed to match a corresponding lever and perch, and can be made to accommodate both vertical and horizontal perch clamp designs (FIG. 39).

The left end of the pivot clamp mounts to the rotatable housing of a hub-locked X-RHA. This connection enables a conventional lever/perch to provide a significant leverage increase for actuating the X-RHA in the forward direction. This is acheived when the rider extends one or more fingers onto the lever's top edge and presses down on the lever as he rotates the grip and housing. The lever becomes a dual-axis tool. In the first axis, the lever creates a horizontal arc as it is pulled in toward the grip. In the second axis, the lever creates a vertical arc as it is pressed down and around the handlebar. In both cases, the lever provides additional leverage. Pivot clamps are customized to fit the type of perch to be mounted. This allows riders with particular preferences for certain lever/perch assemblies to satisfy their preferences and still gain the advantages of a rotating handgrip assembly.

A partial spectrum of left-handlebar control combinations that are possible with the rotatable housing X-RHA, pivot clamp, and conventional lever/perch controls are listed in the table of FIG. 43(33.3/H X-RHA HYBRID COMBINATION TABLE).

Other combinations of X-RHA compound actuators are possible and may occupy the right or left side of the handlebars. For example, a rider with right hand weakness or disability may need to combine actuators on his left-hand side. No doubt other situations and special needs will arise for the X-RHA's.

F. RHA's for Other Applications

As indicated above, the basic rotating handgrip assembly has many uses beyond motorcycle controls. A rotating handgrip assembly in accordance with the invention can be mounted on many types of handles and handlebars. A rotating handgrip assembly in accordance with the invention can be useful for actuating linear mechanisms such as cables, rods, arms, hydraulic pistons, plungers, switches, valves, and other linear devices.

The mechanism can be limited to a fixed range which matches one forward and backward movement of the human hand/wrist; this is similar to the range of a doorknob with a spring-loaded latch. This short stroke application requires few if any modifications to apply to displacing linear mechanisms such as cables, rods, arms, hydraulic pistons, plungers, switches, valves, and other linear devices.

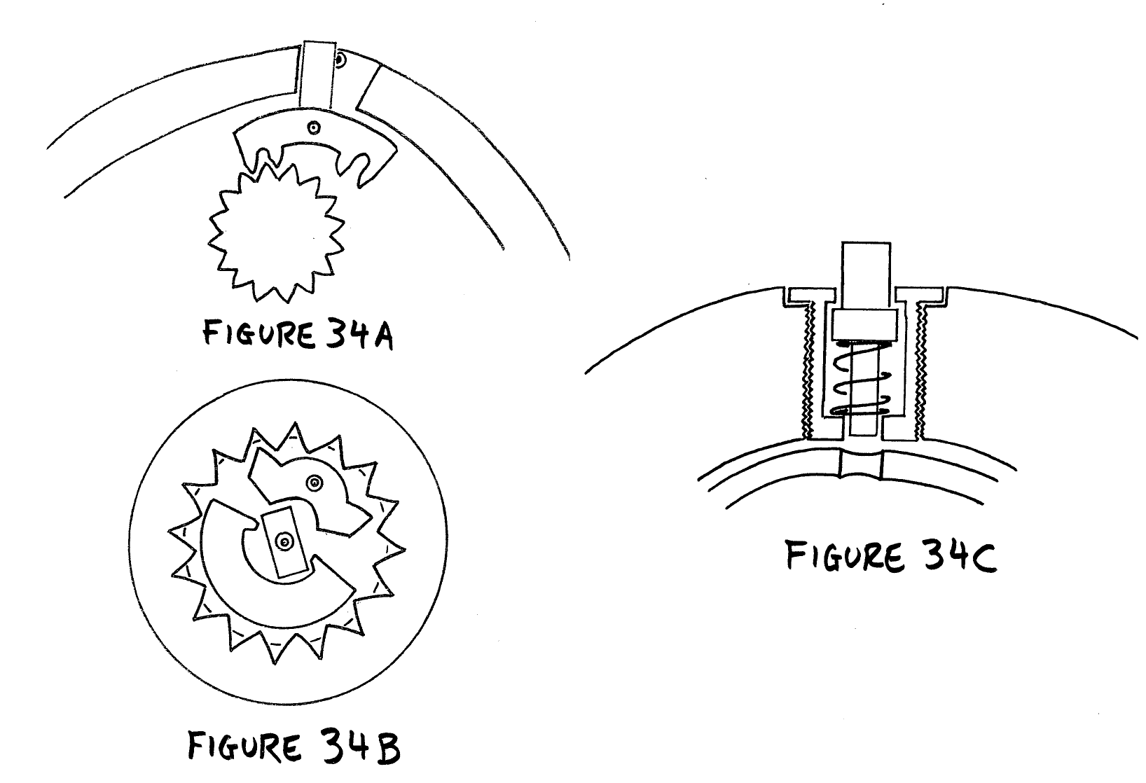

Alternatively, the mechanism can incorporate ratcheting assemblies (FIG. 34) which provide a continuous directional action by locking the gears as the hand resets or releases and rotates backward to continue a forward drive (and vice versa); this is similar to the ratchet of a hand-cranked winch or socket wrench/ratchet drive mechanism.

In the device shown at the upper left of FIG. 34, a tangential ratchet mechanism with a rocking forward and reverse drive selector is integrated with the gear section of the RHA. This drive selector is positioned at the top of the housing for easy access by the thumb or fingers.

In the device shown at the lower left of FIG. 34, an axial ratchet mechanism with a shaft-mounted forward and reverse drive selector is made for the revised core of the pinion. The pinion is manufactured with a larger hub bore and both external and internal teeth. The axial ratchet mechanism fits inside the pinion hub and may include its own bearing. The shaft-mounted forward and reverse drive selector exits the side plate for easy access by the fingers.

The differentiator for ratcheting applications is whether the user's hand maintains a fixed grip or re-grips the RHA for each turn. Fixed grip applications only require a separate axial ratcheting mechanism to be integrated with the core of the pinion. The RHA housing can be stationary or rotating for fixed grip applications. Non-cylindrical tubes and grips having extruded leading edges may be used for the fixed grip assembly.

When the user's hand re-grips the RHA for each turn, the tube and grip must be cylindrical so that the hand does not encounter an irregular surface. Re-grip applications require a tangential ratcheting mechanism to be integrated with the pinion or new rack wheel. This “gear” wheel must be filled out to become a full gear with teeth completely encircling the hub. Consequently, the stop block is removed from the housing. In most cases, re-grip applications will utilize stationary housings.

The screw, coupler, and housing specifications for ratcheting applications can be determined by the total load and total linear displacement required for a particular application. Total load can also determines the gear tooth size and pinion bearing specifications.

Various embodiments of the invention have been described. The descriptions are intended to be illustrative, not limiting. Thus, it will be apparent to one skilled in the art that certain modifications may be made to the invention as described herein without departing from the scope of the claims set out below.

I claim:

1. Apparatus for effecting control of the operation of a vehicle that includes a handlebar, a brake assembly and a clutch assembly, comprising:
a rotatable handgrip assembly mounted on the handlebar, the rotatable handgrip assembly operably connected to the clutch assembly to enable actuation of the clutch assembly; and
a lever assembly attached to the handlebar, the lever assembly operably connected to the brake assembly to enable actuation of the brake assembly.

2. Apparatus as in claim 1, wherein the vehicle is a two-wheeled vehicle.

3. Apparatus as in claim 2, wherein the vehicle is a motorcycle.

4. Apparatus as in claim 1, wherein:
the vehicle comprises a right handlebar adapted to be held by an operator's right hand when the operator is positioned on the vehicle and a left handlebar adapted to be held by the operator's left hand when the operator is positioned on the vehicle; and
the rotatable handgrip assembly is mounted on, and the lever assembly is attached to, one of the right and left handlebars.

5. Apparatus as in claim 1, wherein actuation of the brake assembly by the lever assembly effects control of a rear brake of the vehicle.

6. Apparatus as in claim 5, wherein the vehicle is a motorcycle.

7. Apparatus as in claim 6, wherein:
the vehicle comprises a left handlebar adapted to be held by the operator's left hand when the operator is positioned on the vehicle; and
the rotatable handgrip assembly is mounted on, and the lever assembly is attached to, the left handlebar.
